(19) United States
(12) Patent Application Publication
(10) Pub. No.: US 2025/0130839 A1
(43) Pub. Date: Apr. 24, 2025

(54) METHODS, APPARATUS, AND ARTICLES OF MANUFACTURE FOR DETECTION AND RECONCILIATION OF CONFIGURATION DRIFT

(71) Applicant: VMware LLC, Palo Alto, CA (US)

(72) Inventors: Mallika Anant Kamat, Sunnyvale, CA (US); Benjamin Davini, Watertown, MA (US); Purva Kamat, San Jose, CA (US); Yuedong Mu, San Jose, CA (US)

(21) Appl. No.: 18/491,748

(22) Filed: Oct. 20, 2023

(51) Int. Cl. G06F 9/455

(52) U.S. Cl. CPC G06F 9/45558; G06F 2009/4557

(57) ABSTRACT

Systems, apparatus, articles of manufacture, and methods are disclosed for detection and reconciliation of configuration drift. An example apparatus includes example programmable circuitry to identify a resource associated with a request to reconcile an updated configuration with the resource, the resource to be identified based on a first identifier of the resource included with the request. Additionally, the example programmable circuitry is to identify a finite state machine corresponding to the updated configuration based on a second identifier of the updated configuration included with the request. The example programmable circuitry is also to initiate the finite state machine corresponding to the updated configuration to reconcile the updated configuration with the resource.

### FIELD OF THE DISCLOSURE

This disclosure relates generally to cloud computing and, more particularly, to methods, apparatus, and articles of manufacture for detection and reconciliation of configuration drift.

### BACKGROUND

“Infrastructure-as-a-Service” (also commonly referred to as “IaaS”) generally describes a suite of technologies provided by a service provider as an integrated solution to allow for elastic creation of a virtualized, networked, and pooled computing platform (sometimes referred to as a “cloud computing platform”). Enterprises may use IaaS as a business-internal organizational cloud computing platform (sometimes referred to as a “private cloud”) that gives an application developer access to infrastructure resources, such as virtualized servers, storage, and networking resources. By providing ready access to the hardware resources required to run an application, the cloud computing platform enables developers to build, deploy, and manage the lifecycle of a web application (or any other type of networked application) at a greater scale and at a faster pace.

### BRIEF DESCRIPTION OF THE DRAWINGS

FIGS. 1A and 1B (referred to collectively as FIG. 1) are a block diagram of an example software-defined data center (SDDC) including an SDDC manager.

FIG. 2 is a sequence diagram illustrating example configuration changes to an SDDC manager.

FIGS. 3A and 3B (referred to collectively as FIG. 3) are another sequence diagram illustrating example configuration changes to an SDDC manager.

FIG. 4 is a block diagram illustrating example implementations of the operation manager and domain manager of FIG. 1.

FIG. 5 is a block diagram illustrating example implementations of the example configuration drift reconciliation orchestrator, the example configuration reconciler service, and the example configuration datastore of FIG. 4.

FIG. 6 is an illustration of the example resource map that may be generated by the example resource mapping service of FIG. 5.

FIG. 7 is a block diagram illustrating example performance of an example reconciliation request.

FIG. 8 is a sequence diagram illustrating an example response to a drift availability request.

FIG. 9 is a sequence diagram illustrating an example response to a reconciliation request.

FIG. 10 is a sequence diagram illustrating an example response to a reconciliation status request.

FIG. 11 is a sequence diagram illustrating an example response to a reconciliation precheck request.

FIG. 12 is a flowchart representative of example machine-readable instructions and/or example operations that may be executed, instantiated, and/or performed by example programmable circuitry to implement the configuration drift reconciliation orchestrator of FIG. 5 to respond to a drift availability request.

FIG. 13 is a flowchart representative of example machine-readable instructions and/or example operations that may be executed, instantiated, and/or performed by example programmable circuitry to implement the configuration reconciler service of FIG. 5 to respond to a drift availability request.

FIG. 14 is a flowchart representative of example machine-readable instructions and/or example operations that may be executed, instantiated, and/or performed by example programmable circuitry to implement the configuration reconciler service of FIG. 5 to determine if a configuration drift is applicable to a resource.

FIG. 15 is a flowchart representative of example machine-readable instructions and/or example operations that may be executed, instantiated, and/or performed by example programmable circuitry to implement the configuration drift reconciliation orchestrator of FIG. 5 to respond to a reconciliation request.

FIG. 16 is a flowchart representative of example machine-readable instructions and/or example operations that may be executed, instantiated, and/or performed by example programmable circuitry to implement the configuration reconciler service of FIG. 5 to respond to a reconciliation request.

FIG. 17 is a flowchart representative of example machine-readable instructions and/or example operations that may be executed, instantiated, and/or performed by example programmable circuitry to implement the configuration drift reconciliation orchestrator of FIG. 5 to respond to a reconciliation status request.

FIG. 18 is a flowchart representative of example machine-readable instructions and/or example operations that may be executed, instantiated, and/or performed by example programmable circuitry to implement the configuration reconciler service of FIG. 5 to respond to a reconciliation status request.

FIG. 19 is a flowchart representative of example machine-readable instructions and/or example operations that may be executed, instantiated, and/or performed by example programmable circuitry to implement the configuration drift reconciliation orchestrator of FIG. 5 to respond to a reconciliation precheck request.

FIG. 20 is a flowchart representative of example machine-readable instructions and/or example operations that may be executed, instantiated, and/or performed by example programmable circuitry to implement the configuration reconciler service of FIG. 5 to respond to a reconciliation precheck request.

FIG. 21 is a block diagram of an example processing platform including programmable circuitry structured to execute, instantiate, and/or perform the example machine-readable instructions and/or perform the example operations of FIGS. 12, 15, 17, and/or 19 to implement the configuration drift reconciliation orchestrator of FIG. 4 and/or the example machine-readable instructions and/or perform the example operations of FIGS. 13, 14, 16, 18, and/or 20 to implement the configuration reconciler service of FIG. 4.

FIG. 22 is a block diagram of an example implementation of the programmable circuitry of FIG. 21.

FIG. 23 is a block diagram of another example implementation of the programmable circuitry of FIG. 21.

FIG. 24 is a block diagram of an example software/firmware/instructions distribution platform (e.g., one or more servers) to distribute software, instructions, and/or firmware (e.g., corresponding to the example machine-readable instructions of FIGS. 12, 13, 14, 15, 16, 17, 18, 19, and/or 20) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

Cloud computing platforms provide many powerful capabilities for performing computing operations. For example, cloud computing allows ubiquitous, convenient, on-demand network access to a shared pool of configurable computing resources. A cloud computing customer can request allocations of such resources to support one or more services utilized by the cloud computing customer. For example, when a customer requests to run one or more services in the cloud computing environment, one or more workload domains may be created based on resources in the shared pool of configurable computing resources.

Cloud service providers offer services to allow customers to develop applications to execute workloads. Additionally, cloud service providers offer cloud resources, such as management services, to manage virtual machines (VMs) and container workloads. Such management services may be implemented by a group of physical machines and virtual machines (VM) that host cloud infrastructure components for managing a software defined data center (SDDC) in a cloud computing environment that supports one or more customer services. In some examples, an SDDC management service may be referred to as an SDDC manager.

Periodically, a cloud service provider may provide a software release to introduce one or more modifications to a prescribed configuration of software stack components deployed throughout an SDDC. Configuration modifications between releases may be referred to as configuration drift. Configuration drift may result from configuration changes to bill of materials (BOM) components of an SDDC, configuration fixes to BOM components (e.g., altering an availability configuration on a cluster, altering a relocation mode for a network virtualization service, modifying an overlay transport zone for a network virtualization service, etc.), or configuration features of BOM components.

Modern SDDC managers provide a framework to apply configuration drifts (e.g., configuration modifications) to an SDDC. For example, a configuration drift can be applied as a configuration drift bundle after an SDDC manager update and before BOM update. To implement a configuration drift in modern SDDC managers, a customer utilizing an SDDC manager provides a configuration drift bundle to the SDDC manager. Example configuration drift bundles in modern SDDC managers include metadata and code and/or binaries to perform updates and/or modifications to resources associated with the configuration drift(s). Modern SDDC managers apply a configuration drift bundle to bring parity between brownfield and greenfield configurations. For example, a greenfield configuration may refer to a configuration of a computer infrastructure where none existed before, for example, in a new office. In contrast, a brownfield configuration may refer to an update or addition of resources to an existing computer infrastructure that already includes deployed components in service. In examples disclosed herein, greenfield refers to an area in which a network and/or a resource does not yet operate but is targeted for a new deployment such that an additional deployment will not need to inter-operate with an already existing network and/or resource. In examples disclosed herein, brownfield refers to an area in which a network and/or a resource already exists and is targeted for an additional deployment such that an additional deployment will likely inter-operate with the already existing network and/or resource.

In modern SDDC managers, when a brownfield deployment undergoes a release-to-release update, the brownfield configuration is synchronized to a greenfield configuration included with the release-to-release update. However, if a customer implemented custom configurations in the brownfield deployment, the custom configurations are overridden during update. Such overridden custom configurations may create issues in customer deployments, workloads, and/or workflows. In modern SDDC managers, there is no visibility for customers to manage configuration updates. As such, when an SDDC manager undergoes a configuration update, the configuration update is applied to the SDDC manager in bulk. Additionally, modern SDDC managers do not include unified configuration management for SDDC resources (e.g., a host, a cluster, an edge cluster, a domain, etc.).

Furthermore, when designing day-N (e.g., expansion) workflows, customers assume that an SDDC resource configuration matches a greenfield configuration. Typically, an SDDC manager applies a configuration drift in bulk on all resources managed by the SDDC manager after the SDDC manager has updated the configuration of the SDDC manager but before updating the configuration of SDDC components. However, as described above, this sequence of configuration drift application can cause errors. For example, according to this sequence, an SDDC manager will apply a greenfield configuration for an SDDC manager before a customer product is updated to the BOM version associated with greenfield configuration. Alternate options of drift application at product update granularity per domain or at the end of BOM update expose a window of time where a day-N workflow could fail.

Moreover, the tight coupling in time between SDDC manager updates and SDDC BOM updates reduces the reliability of SDDC manager updates. For example, an SDDC manager can be considered updated when a configuration drift bundle has been applied to the SDDC manager after an SDDC has been updated. As such, the time to update the SDDC manager scales with number of domains managed by the SDDC manager and any configuration drift failure blocks subsequent SDDC updates. Additionally, asynchronously patching of an SDDC manager is accompanied by a configuration drift application which becomes an impediment to offering the SDDC manager as a standalone product.

Examples disclosed herein include on-demand, at-will, selective reconciliation of configuration updates and fixes to customer environments at different resource granularities. For example, disclosed methods, apparatus, and articles of manufacture allow for configuration reconciliation at the granularity of an SDDC resource (e.g., at a domain level, at a cluster level, at a host level, etc.) and when the configuration drifts become relevant and/or applicable based on BOM versions. Additionally, according to examples disclosed herein a customer can view available configuration drifts, respective priorities associated with the configuration drifts, and the resources to which the configuration drifts are applicable at any time and the customer can plan selective reconciliation of a configuration drift whenever the customer elects.

Examples disclosed herein also detect anomalous configuration drifts and allow for policy-based remediation. For example, a customer could choose to selectively reconcile a configuration if desired or set a policy for automated reconciliation when a configuration drift is detected. Additionally, disclosed methods, apparatus, and articles of manufacture check whether a configuration drift is applicable to a resource before attempting to reconcile the configuration drift with the resource to reduce the occurrence of (e.g., prevent) reconciliation failures and/or service disruptions. In examples disclosed herein, the service responsible for seeding a configuration is responsible for managing the reliability and resiliency of the configuration over time as the configuration is updated (e.g., drifts). Furthermore, examples disclosed herein can perform customer specific custom configurations to provide a curated experience. Accordingly, examples disclosed herein provide unified configuration management for an SDDC resource (e.g., a host, a cluster, an edge cluster, a domain, etc.).

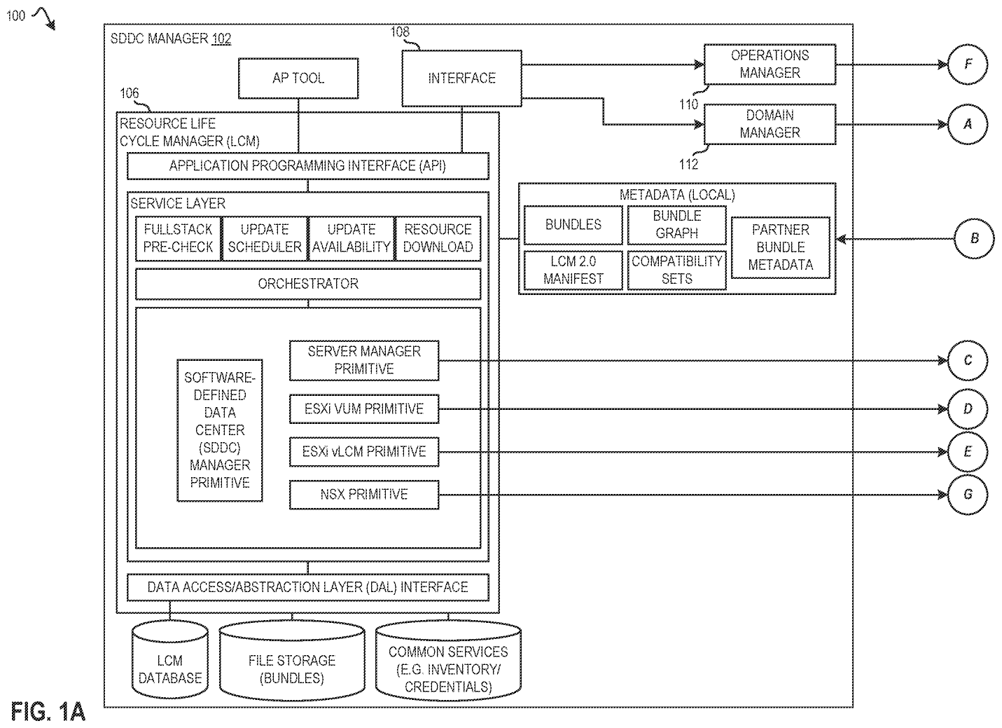

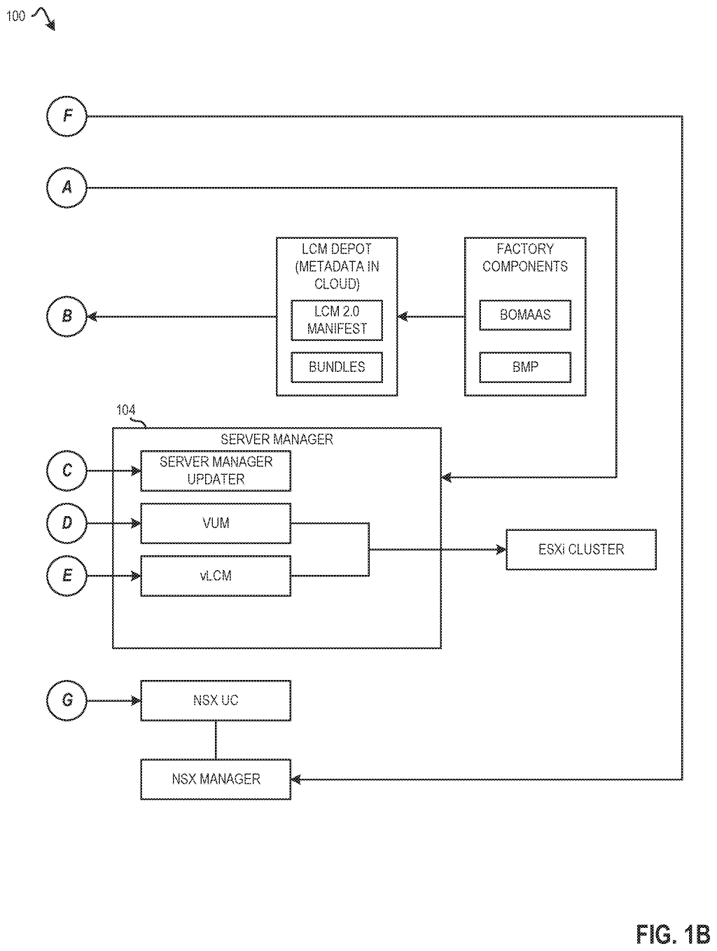

FIG. 1 is a block diagram of an example SDDC 100 including an SDDC manager 102. In the example of FIG. 1, the SDDC manager 102 is implemented by one or more virtual machines (VMs) and manages VM and/or container workloads implemented on cloud computing resources of the SDDC 100. For example, the SDDC manager 102 manages one or more management services that manage one or more virtualization layers of the SDDC 100.

In the illustrated example of FIG. 1, the SDDC 100 also includes an example server manager 104. The example server manager 104 of FIG. 1 manages physical server resources for use in virtual infrastructures. For example, the server manager 104 can be used to manage physical resources for allocation to virtual machines and/or containers in virtual environments. In the example of FIG. 1, the server manager 104 may be implemented by the VMware vCenter® virtual infrastructure server (e.g., a server management instance).

In the illustrated example of FIG. 1, the one or more virtualization layers of the SDDC 100 expose various virtualized compute, networking, and/or storage resources out of underlying physical hardware resources. The one or more virtualization layers use the underlying hardware infrastructure as a basis of aggregation to create and provide operational views, handle fault domains, and scale to accommodate workload profiles. The one or more virtualization layers keep track of available capacity in the underlying hardware infrastructure, maintain a view of a logical pool of virtual resources throughout the SDDC life cycle, and translate logical resource provisioning to allocation of physical hardware resources.

In the illustrated example of FIG. 1, the SDDC manager 102 interfaces with components of a virtual system solutions provider. For example, the SDDC manager 102 may be implemented by VMware® Cloud Foundation (VCF). As such, in the example of FIG. 1, the SDDC manager 102 interfaces with components of the VCF such as an example VMware vSphere® virtualization infrastructure components suite, an example VMware vCenter® virtual infrastructure server, an example ESXi™ hypervisor component, an example VMware NSX® network virtualization platform (e.g., a network virtualization component or a network virtualizer), an example VMware NSX® network virtualization manager, and an example VMware vSAN™ network data storage virtualization component (e.g., a network data storage virtualizer). In the illustrated example, the SDDC manager 102 communicates with these components to manage and present the logical view of underlying resources such as hosts and clusters. The SDDC manager 102 also uses the logical view for orchestration and provisioning of workloads.

In the illustrated example of FIG. 1, the VMware NSX® network virtualization platform (e.g., a network virtualization component or a network virtualizer) virtualizes network resources such as physical hardware switches to provide software-based virtual networks. The VMware NSX® network virtualization platform enables treating physical network resources (e.g., switches) as a pool of transport capacity. In some examples, the VMware NSX® network virtualization platform also provides network and security services to virtual machines with a policy-driven approach.

In the illustrated example of FIG. 1, the VMware NSX® network virtualization manager (e.g., a virtualization management instance) manages virtualized network resources such as physical hardware switches to provide software-based virtual networks. In the illustrated example, the VMware NSX® network virtualization manager is a centralized management component of the VMware NSX® network virtualization platform and runs as a virtual appliance on an ESXi host (e.g., one of the physical servers running an ESXi™ hypervisor). In the illustrated example, a VMware NSX® network virtualization manager manages a single vCenter server environment implemented using the VMware vCenter® virtual infrastructure server. In the illustrated example, the VMware NSX® network virtualization manager is in communication with the VMware vCenter® virtual infrastructure server, the ESXi™ hypervisor component, and the VMware NSX® network virtualization platform.

In the illustrated example of FIG. 1, the SDDC manager 102 includes an example resource life cycle manager (LCM) 106. In the example of FIG. 1, the resource LCM 106 manages the lifecycle of the SDDC manager 102. For example, the resource LCM 106 includes software primitives to implement the lifecycle of the SDDC manager 102 and/or other components of the SDDC 100. For example, in addition to a primitive to implement the lifecycle of the SDDC manager 102, the resource LCM 106 (e.g., a cloud resource LCM) includes primitives to implement the lifecycle of components of the VCF (e.g., a primitive to implement the lifecycle of a VMware vCenter® virtual infrastructure server, a primitive to implement the lifecycle of an update manager for an ESXi™ hypervisor, a primitive to implement the lifecycle of an LCM for an ESXi™ hypervisor, a primitive to implement the lifecycle of a VMware NSX® network virtualization platform, etc.) and/or a primitive to implement the lifecycle of a third-party service.

In the illustrated example of FIG. 1, the SDDC manager 102 includes an example interface 108, an example operations manager 110, and an example domain manager 112. In the example of FIG. 1, the interface 108 may be implemented by a user interface (UI) through which a user (e.g., a customer of a cloud service provider) may access the SDDC manager 102 and/or an application programming interface (API) client through which a program may access the SDDC manager 102. In the example of FIG. 1, the operations manager 110 is a manager service that provides a unified management platform to improve (e.g., optimize), plan, and scale hybrid cloud deployments from applications to infrastructure. For example, the operations manager 110 can improve common SDDC operations (e.g., day-N workflows) such as password and/or certificate management of SDDC components. In the example of FIG. 1, the domain manager 112 is a manager service that is associated with a particular type of information technology (IT) domain, such as a network, a system, an application, or an application service. For example, a domain manager that manages an internet protocol (IP) network transport domain may be referred to as an IP manager. In the example of FIG. 1, the domain manager 112 adds and/or removes (e.g., scales) resources to and/or from a cloud infrastructure (e.g., a hybrid cloud infrastructure). For example, the domain manager 112 adds and/or removes domains to and/or from a cloud infrastructure and expands and/or contracts domains of the cloud infrastructure. In some examples, the domain manager 112 includes a repository of the managed topology and a problem correlation model to monitor network elements. In some examples, the domain manager 112 uses correlation technology to pinpoint a root cause of a failure and diagnose an effect of the failure on related network elements.

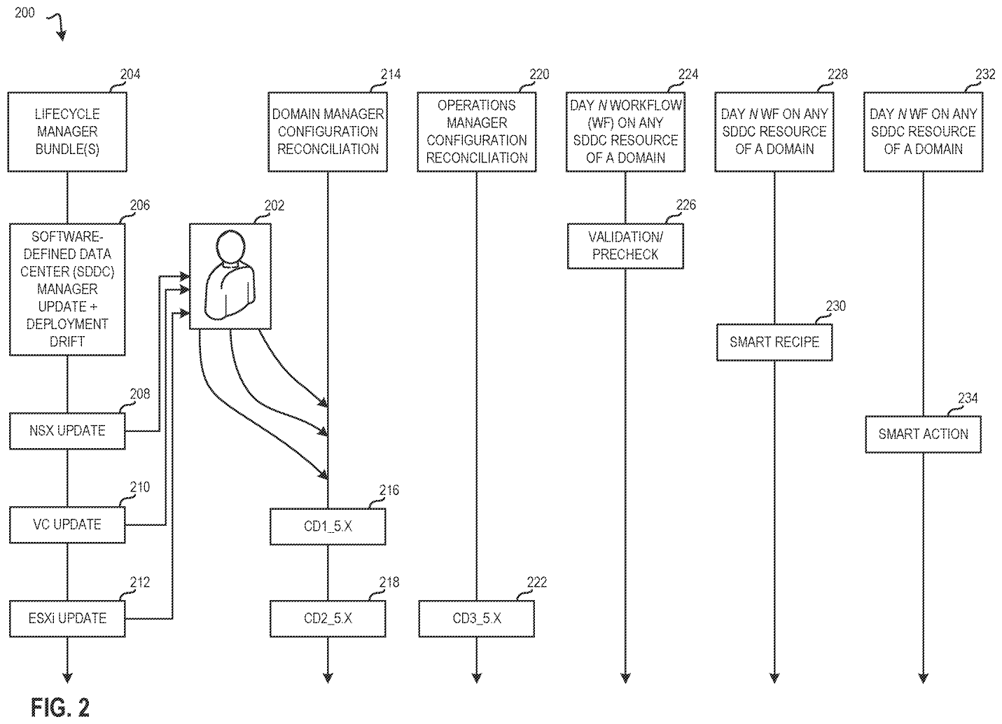

In the illustrated example of FIG. 1, the SDDC manager 102 and/or one or more resources managed by the operations manager 110 and/or the domain manager 112 may be updated to a new configuration (e.g., via metadata and code and/or binaries communicated to the resource LCM 106 via the interface 108). For example, FIG. 2 is a sequence diagram 200 illustrating example configuration changes to an SDDC manager. In the example of FIG. 2, an example configuration change may result from an example LCM bundle 204 communicated to an example user 202 of the SDDC manager. For example, the example LCM bundle 204 includes an example SDDC manager update 206 (including a deployment drift), an example update 208 to a VMware NSX® network virtualization platform, an example update 210 to a VMware vCenter® virtual infrastructure server, and an example update 212 to an ESXi™ hypervisor. For example, the LCM bundle 204 may be retrieved by the user 202 from a cloud service provider. One or more of the SDDC manager update 206, the update 208, the update 210, or the update 212 may result in a change to a configuration of one or more resources of the SDDC.

In the illustrated example of FIG. 2, instead of applying the LCM bundle 204 in bulk, the user 202 can elect to apply updates on a per resource basis. For example, the user 202 can elect to perform example domain manager configuration reconciliation 214 by applying an example first configuration 216 to one or more resources and/or metadata managed by the domain manager and an example second configuration 218 to one or more resources and/or metadata managed by the domain manager. Additionally, the user 202 can elect to perform example operations manager configuration reconciliation 220 by applying an example third configuration 222 to one or more resources and/or metadata managed by the operations manager.

In the illustrated example of FIG. 2, the user 202 may apply an example first day-N workflow 224 on an SDDC resource of a managed domain. Advantageously, the domain manager and/or the operations manager perform an example validation and/or precheck 226 to confirm whether an updated configuration has been applied to the resource before permitting the first day-N workflow 224 to run. Additionally, the user 202 may apply an example second day-N workflow 228 on an SDDC resource of a managed domain. Advantageously, the domain manager and/or the operations manager implement an example smart recipe 230 to perform the second day-N workflow 228. For example, when implementing the smart recipe 230, the domain manager and/or the operations manager may exclude some actions of the recipe if an updated configuration has not been applied to the resource. The user 202 may also apply an example third day-N workflow 232 on an SDDC resource of a managed domain. Advantageously, the domain manager and/or the operations manager implement an example smart action 234 to perform the third day-N workflow 232. For example, the domain manager and/or the operations manager performs a polymorphic action to implement the smart action 234 based on the version of the configuration currently applied to the resource.

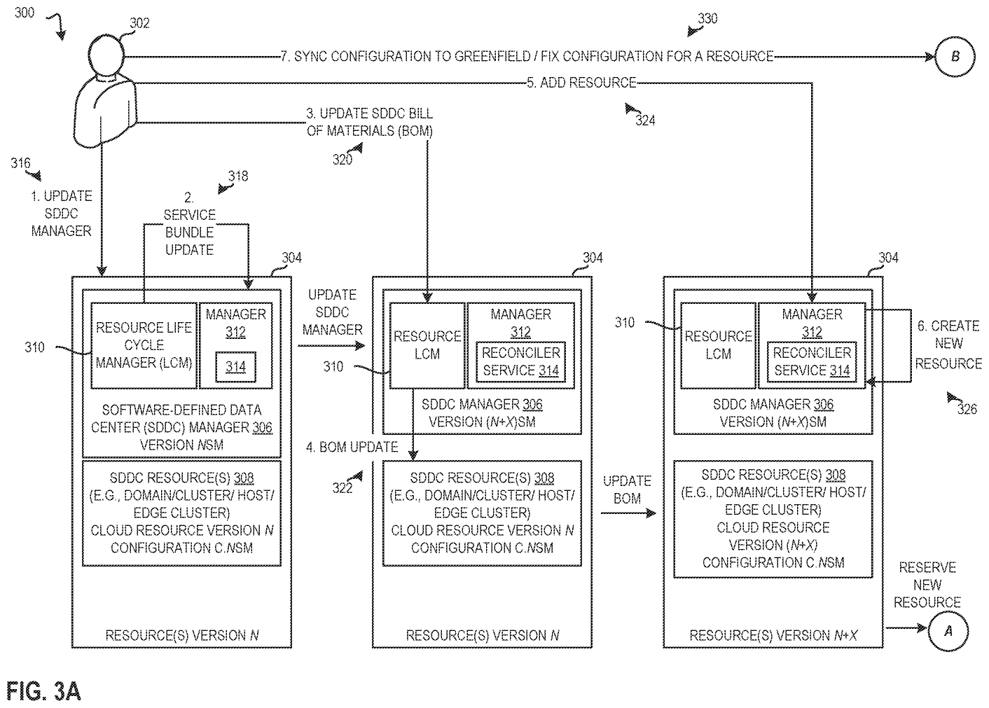

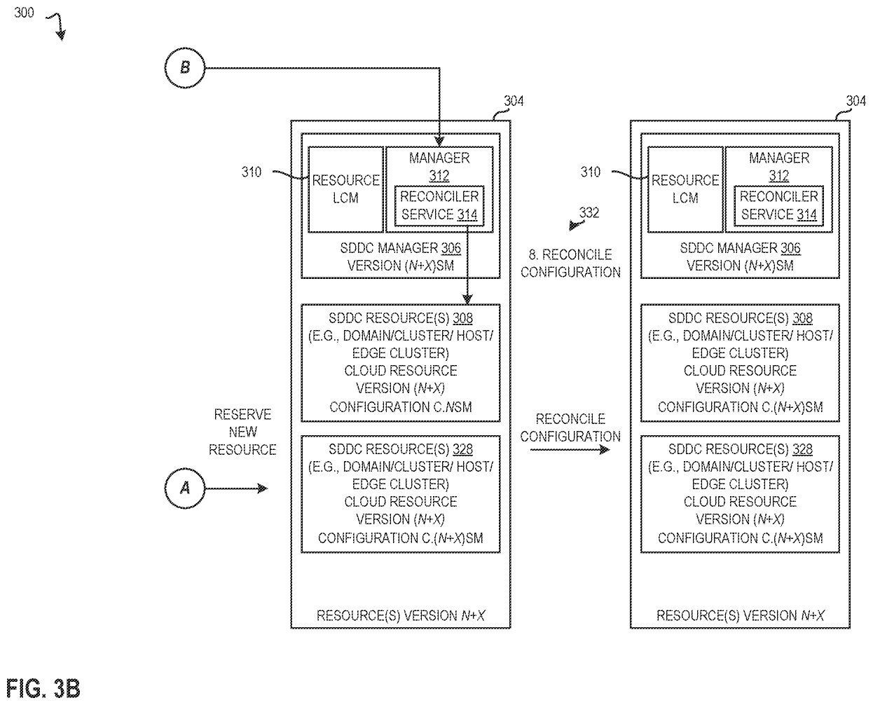

FIG. 3 is another sequence diagram 300 illustrating example configuration changes to an SDDC manager. In the example of FIG. 3, an example user 302 interacts with an example resource(s) 304 which includes an example SDDC manager 306 managing an example SDDC resource 308. The example SDDC manager 306 of FIG. 3 includes an example resource LCM 310 and an example manager service 312. The example manager service 312 includes an example reconciler service 314. For example, the reconciler service 314 may be implemented by the example configuration drift reconciliation orchestrator 402 and/or the example configuration reconciler service 404 described further herein.

In the illustrated example of FIG. 3, at an example first operation 316, the user 302 elects to perform an update on the SDDC manager 306. For example, an SDDC manager update involves updating the SDDC manager 306 from a first version (e.g., version N) to a second version (e.g., version N+X). At an example second operation 318, the resource LCM 310 updates the service bundle of the SDDC manager 306. For example, the resource LCM 310 updates the SDDC manager 306 to the second version (e.g., version N+X).

In the illustrated example of FIG. 3, at an example third operation 320, the user 302 elects to update an SDDC BOM. For example, an SDDC BOM update involves updating the SDDC resource 308 from a first version (e.g., version N) to a second version (e.g., version N+X). At an example fourth operation 322, the resource LCM 310 updates the BOM of the SDDC resource 308. For example, the resource LCM 310 updates the SDDC resource 308 to the second version (e.g., version N+X). By updating the SDDC resource 308 to the second version (e.g., version N+X), the resource LCM 310 also updates the resource(s) 304 to the second version (e.g., version N+X).

In the illustrated example of FIG. 3, at an example fifth operation 324, the user 302 elects to add a resource to the resource(s) 304. For example, the user 302 accesses a user interface (e.g., the interface 108) to instruct the manager service 312 of the SDDC manager 306 to add a resource to the resource(s) 304. At an example sixth operation 326, the manager service 312 (e.g., the operations manager 110 and/or the domain manager 112) creates a new SDDC resource 328 for the resource(s) 304. In the example of FIG. 3, the manager service 312 added the new SDDC resource 328 with second version (version N+X) and a second configuration version (version C.(N+X)).

In the illustrated example of FIG. 3, at an example seventh operation 330, the user 302 elects to synchronize a configuration of the SDDC resource 308 with a configuration of the new SDDC resource 328. For example, even though the version of the SDDC resource 308 matches the version of the new SDDC resource 328, the configuration version of the SDDC resource 308 (e.g., version C.N) does not match the configuration version of the new SDDC resource 328 (e.g., version C.(N+X)). As such, at an example eighth operation, 332, the manager service 312 updates the configuration of the SDDC resource 308 to the second configuration version (e.g., version C.(N+X)).

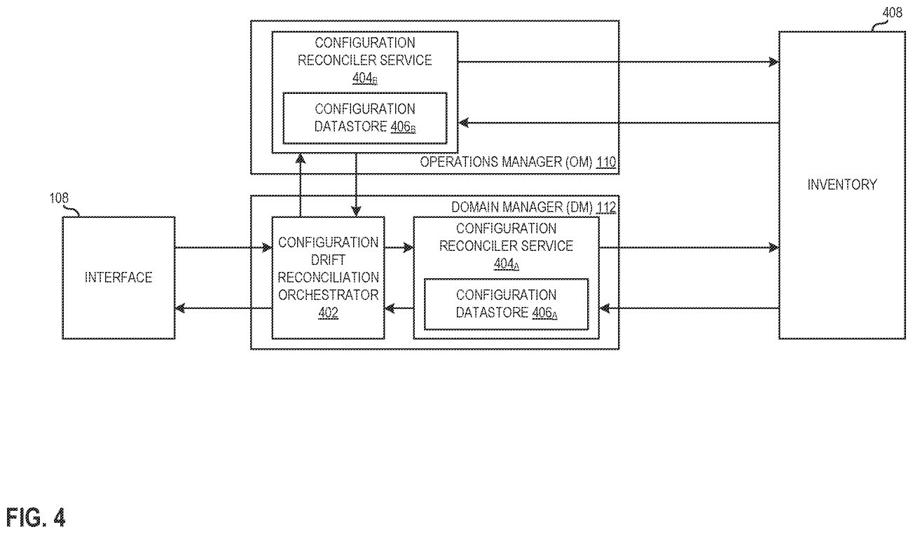

FIG. 4 is a block diagram illustrating example implementations of the operations manager 110 and domain manager 112 of FIG. 1. In the example of FIG. 4, the domain manager 112 includes a configuration drift reconciliation orchestrator 402 and an example first configuration reconciler service 404_{A}. Additionally, the first configuration reconciler service 404_{A} includes an example first configuration datastore 406_{A}. In the example of FIG. 4, the operations manager 110 includes an example second configuration reconciler service 404_{B} that includes an example second configuration datastore 406_{B}.

In the illustrated example of FIG. 4, one or more of the configuration drift reconciliation orchestrator 402, the first configuration reconciler service 404_{A}, the first configuration datastore 406_{A}, the second configuration reconciler service 404_{B}, and/or the second configuration datastore 406_{B} may be instantiated (e.g., creating an instance of, bring into being for any length of time, materialize, implement, etc.) by programmable circuitry such as a Central Processor Unit (CPU) executing first instructions. Additionally or alternatively, the configuration drift reconciliation orchestrator 402, the first configuration reconciler service 404_{A}, the first configuration datastore 406_{A}, the second configuration reconciler service 404_{B}, and/or the second configuration datastore 406_{B} of FIG. 4 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 4 may, thus, be instantiated at the same or different times. Some or all of the circuitry of FIG. 4 may be instantiated, for example, in one or more threads executing concurrently on hardware and/or in series on hardware. Moreover, in some examples, some or all of the circuitry of FIG. 4 may be implemented by microprocessor circuitry executing instructions and/or FPGA circuitry performing operations to implement one or more virtual machines and/or containers.

In the illustrated example of FIG. 4, the configuration drift reconciliation orchestrator 402 is coupled to the interface 108 (FIG. 1), the first configuration reconciler service 404_{A} and the second configuration reconciler service 404_{B}. In the example of FIG. 4, the configuration drift reconciliation orchestrator 402 acts as a multiplexer and demultiplexer between the interface 108 and the first configuration reconciler service 404_{A} and the second configuration reconciler service 404_{B}. For example, each resource of the SDDC 100 may be managed by one or more manager services (e.g., the operations manager 110 and/or the domain manager 112) of the SDDC manager 102. As such, the configuration drift reconciliation orchestrator 402 sequences the reconciliation of configuration drifts and/or aggregates configuration drifts that are applicable to the resources managed by the one or more manager service of the SDDC manager 102.

In the illustrated example of FIG. 4, the first configuration reconciler service 404_{A} is coupled to the configuration drift reconciliation orchestrator 402 and an example inventory 408 of resources managed by the SDDC manager 102. In the example of FIG. 4, the first configuration reconciler service 404_{A} manages configurations of resources managed by the domain manager 112. For example, in response to a request to report available drifts to be reconciled for a resource managed by the domain manager 112, the first configuration reconciler service 404_{A} fetches and returns at least one applicable drift to the configuration drift reconciliation orchestrator 402. Additionally, for example, in response to a request to reconcile an applicable drift with a resource managed by the domain manager 112, the first configuration reconciler service 404_{A} invokes an operation (e.g., defined by a recipe or cookbook) to reconcile the configuration drift (e.g., update the resource from a first configuration to a second configuration).

In the illustrated example of FIG. 4, the first configuration datastore 406_{A} includes configuration drift metadata indicating a mapping between a configuration drift and one or more operations to be applied to a resource managed by the domain manager 112 to reconcile the configuration drift. Additionally, the first configuration datastore 406_{A} includes data indicative of when a new configuration was introduced, a version to which a configuration drift is applicable, and/or how the configuration is to be applied (e.g., a recipe, a cookbook, etc.). In the example of FIG. 4, the first configuration datastore 406_{A} may be implemented by a volatile memory (e.g., a Synchronous Dynamic Random Access Memory (SDRAM), Dynamic Random Access Memory (DRAM), RAMBUS Dynamic Random Access Memory (RDRAM), etc.) and/or a non-volatile memory (e.g., flash memory). The first configuration datastore 406_{A} may additionally or alternatively be implemented by one or more double data rate (DDR) memories, such as DDR, DDR2, DDR3, DDR4, DDR5, mobile DDR (mDDR), DDR SDRAM, etc. The first configuration datastore 406_{A} may additionally or alternatively be implemented by one or more mass storage devices such as hard disk drive(s) (HDD(s)), compact disk (CD) drive(s), digital versatile disk (DVD) drive(s), solid-state disk (SSD) drive(s), Secure Digital (SD) card(s), CompactFlash (CF) card(s), etc. While in the illustrated example the first configuration datastore 406_{A} is illustrated as a single datastore, the first configuration datastore 406_{A} may be implemented by any number and/or type(s) of datastores. Furthermore, the data stored in the first configuration datastore 406_{A} may be in any data format such as, for example, binary data, comma delimited data, tab delimited data, structured query language (SQL) structures, etc.

In the illustrated example of FIG. 4, the second configuration reconciler service 404_{B} is coupled to the configuration drift reconciliation orchestrator 402 and the inventory 408 of resources managed by the SDDC manager 102. In the example of FIG. 4, the second configuration reconciler service 404_{B} manages configurations of resources managed by the operations manager 110. For example, in response to a request to report available drifts to be reconciled for a resource managed by the operations manager 110, the second configuration reconciler service 404_{B} fetches and returns at least one applicable drift to the configuration drift reconciliation orchestrator 402. Additionally, for example, in response to a request to reconcile an applicable drift with a resource managed by the operations manager 110, the second configuration reconciler service 404_{B} invokes an operation (e.g., defined by a recipe or cookbook) to reconcile the configuration drift (e.g., update the resource from a first configuration to a second configuration).

In the illustrated example of FIG. 4, the second configuration datastore 406_{B} includes configuration drift metadata indicating a mapping between a configuration drift and one or more operations to be applied to a resource managed by the operations manager 110 to reconcile the configuration drift. Additionally, the second configuration datastore 406_{B} includes data indicative of when a new configuration was introduced, a version to which a configuration drift is applicable, and/or how the configuration is to be applied (e.g., a recipe, a cookbook, etc.). In the example of FIG. 4, the second configuration datastore 406_{B} may be implemented by a volatile memory (e.g., a SDRAM, DRAM, RDRAM, etc.) and/or a non-volatile memory (e.g., flash memory). The second configuration datastore 406_{B} may additionally or alternatively be implemented by one or more DDR memories, such as DDR, DDR2, DDR3, DDR4, DDR5, mDDR, DDR SDRAM, etc. The second configuration datastore 406_{B} may additionally or alternatively be implemented by one or more mass storage devices such as HDD(s), CD drive(s), DVD drive(s), SSD drive(s), SD card(s), CF card(s), etc. While in the illustrated example the second configuration datastore 406_{B} is illustrated as a single datastore, the second configuration datastore 406_{B} may be implemented by any number and/or type(s) of datastores. Furthermore, the data stored in the second configuration datastore 406_{B} may be in any data format such as, for example, binary data, comma delimited data, tab delimited data, SQL structures, etc.

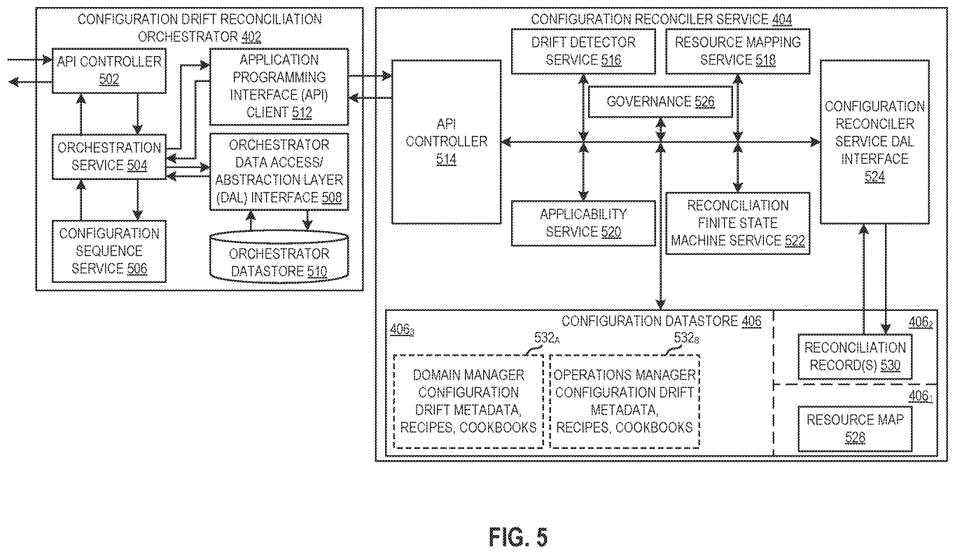

FIG. 5 is a block diagram illustrating example implementations of the example configuration drift reconciliation orchestrator 402, the example configuration reconciler service 404, and the example configuration datastore 406 of FIG. 4. In the example of FIG. 5, the configuration drift reconciliation orchestrator 402 includes an example API controller 502, an example orchestration service 504, an example configuration sequence service 506, an example orchestrator data access and/or abstraction layer (DAL) interface 508, an example orchestrator datastore 510, and an example API client 512. Additionally, in the example of FIG. 5, the configuration reconciler service 404 includes the configuration datastore 406, an example API controller 514, an example drift detector service 516, an example resource mapping service 518, an example applicability service 520, an example reconciliation finite state machine (FSM) service 522, an example configuration reconciler service DAL interface 524, and an example governance service 526.

In the illustrated example of FIG. 5, one or more of the API controller 502, the orchestration service 504, the configuration sequence service 506, the orchestrator DAL interface 508, the orchestrator datastore 510, or the API client 512 may be instantiated (e.g., creating an instance of, bring into being for any length of time, materialize, implement, etc.) by programmable circuitry such as a Central Processor Unit (CPU) executing first instructions. Additionally or alternatively, one or more of the API controller 502, the orchestration service 504, the configuration sequence service 506, the orchestrator DAL interface 508, the orchestrator datastore 510, or the API client 512 of FIG. 5 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 5 may, thus, be instantiated at the same or different times. Some or all of the circuitry of FIG. 5 may be instantiated, for example, in one or more threads executing concurrently on hardware and/or in series on hardware. Moreover, in some examples, some or all of the circuitry of FIG. 5 may be implemented by microprocessor circuitry executing instructions and/or FPGA circuitry performing operations to implement one or more virtual machines and/or containers.

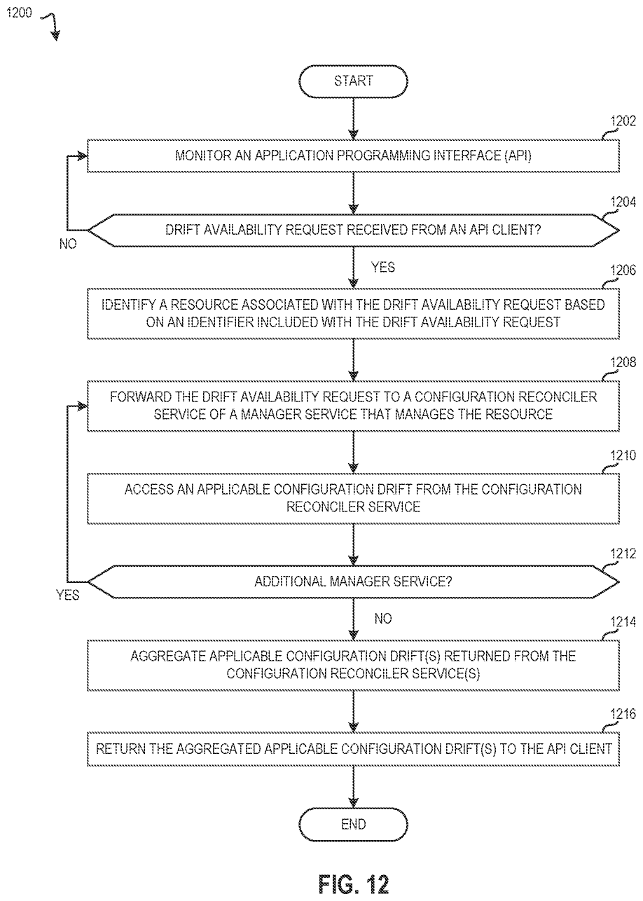

In the illustrated example of FIG. 5, the API controller 502 is coupled to the orchestration service 504. Additionally, the API controller 502 is coupled to the interface 108 (FIG. 1). In some examples, the API controller 502 is instantiated by programmable circuitry executing API instructions and/or configured to perform operations such as those represented by the flowchart(s) of FIGS. 12, 15, 17, and/or 19.

In the illustrated example of FIG. 5, the API controller 502 exposes a representational state transfer (REST) API that can be accessed via the interface 108. As such, a user and/or an API client can transmit an API request to the configuration drift reconciliation orchestrator 402 via the API controller 502. For example, a user may access a UI to transmit a drift availability request to the configuration drift reconciliation orchestrator 402 to retrieve a report of applicable drifts for a particular resource (e.g., via a GET /v1/config-drifts request). In the example of FIG. 5, a drift availability request includes an identifier of a resource associated with the drift availability request. In the example of FIG. 5, a drift availability request can identify a resource at a variety of granularities. For example, a drift availability request can request applicable drifts for a host, a cluster (e.g., a group of host devices), an edge cluster (e.g., a cluster of one or more resources (e.g., physical and/or virtual resources) including a resource pool and storage), a domain (e.g., an entity including one or more clusters, host, and/or edge clusters), among others. In the example of FIG. 5, the report generated by a drift availability request includes an indication of applicable configuration drift(s) for a resource, a description of the applicable configuration drift(s), a severity of the applicable configuration drift(s) (e.g., determined based on a difference between a current configuration of the resource and the updated configuration(s)), a granularity at which the applicable configuration drift(s) can be applied, version(s) of product(s) to which the applicable configuration drift(s) are applicable, and a stock keeping unit (SKU) applicability field indicative of a version of a VMware® Cloud Foundation (VCF) and/or a hyperconverged infrastructure (e.g., VMware® VxRAIL) environment in which an SDDC manager is operating.

In the illustrated example of FIG. 5, a user and/or an API client can transmit a reconciliation request to the configuration drift reconciliation orchestrator 402 via the API controller 502. For example, a user may access a UI to transmit a reconciliation request to the configuration drift reconciliation orchestrator 402 to request that a configuration of a resource be reconciled to an updated configuration (e.g., via a POST /v1/config-drift-reconciliations request). In the example of FIG. 5, a reconciliation request includes an identifier of a resource to be reconciled according to the reconciliation request and one or more identifiers of configuration drifts (e.g., updated configurations) with which the resource is to be reconciled. In some examples, a reconciliation request includes an indication to reconcile all applicable drifts for a resource. In the example of FIG. 5, a reconciliation request can request reconciliation of a configuration drift for a resource at a variety of granularities. For example, a reconciliation request can request reconciliation a configuration drift for a host, a cluster, an edge cluster, a domain, among others. In some examples, generation of reconciliation requests may be automated. For example, a user may set a reconciliation policies indicative of conditions under which a configuration drift should automatically be reconciled (e.g., reconcile configuration drifts as the configuration drifts become available).

In the illustrated example of FIG. 5, a user and/or an API client can transmit a reconciliation status request to the configuration drift reconciliation orchestrator 402 via the API controller 502. For example, a user may access a UI to transmit a request to the configuration drift reconciliation orchestrator 402 to get the status of a configuration drift reconciliation request (e.g., via a GET /v1/config-drift-reconciliations request and/or a GET /v1/tasks request). As such a user can track configuration drift reconciliation for a resource. In the example of FIG. 5, a reconciliation status request includes an identifier of a reconciliation task (e.g., a reconciliation parent task) for which the status is requested. In the example of FIG. 5, a reconciliation status request can request a status record of a configuration drift reconciliation task for a resource at a variety of granularities. For example, a reconciliation status request can request a status record of a configuration drift reconciliation task for a host, a cluster, an edge cluster, a domain, among others.

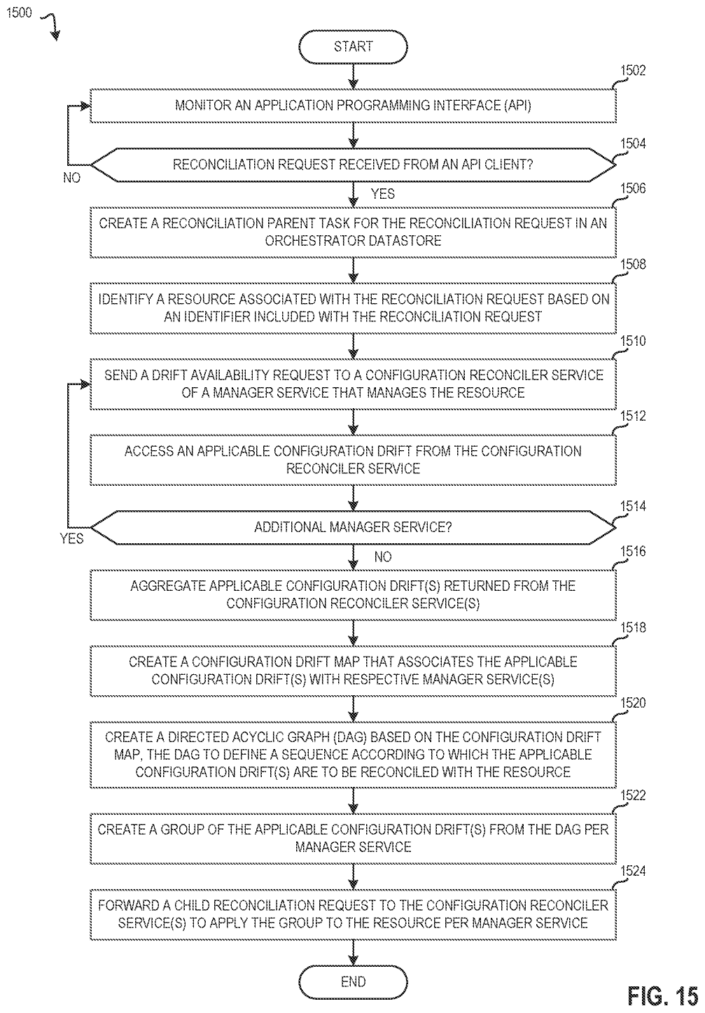

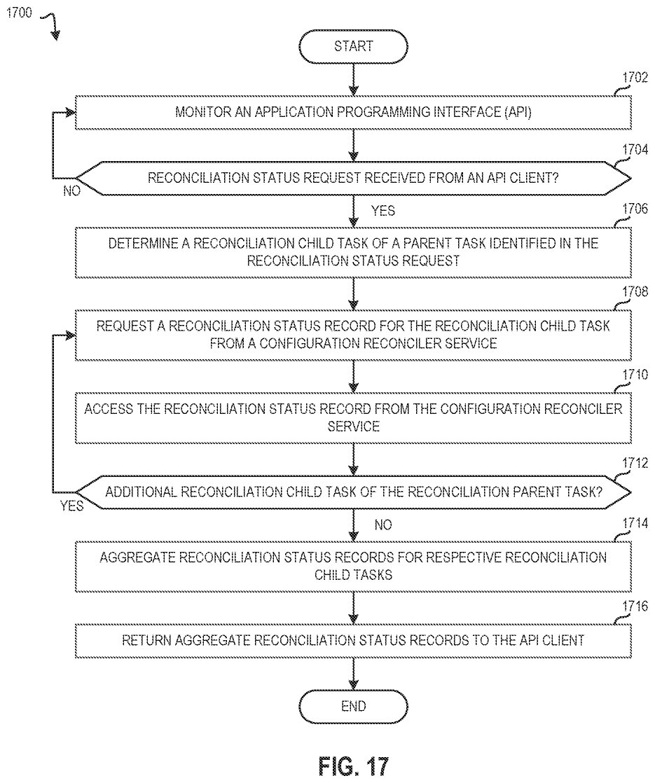

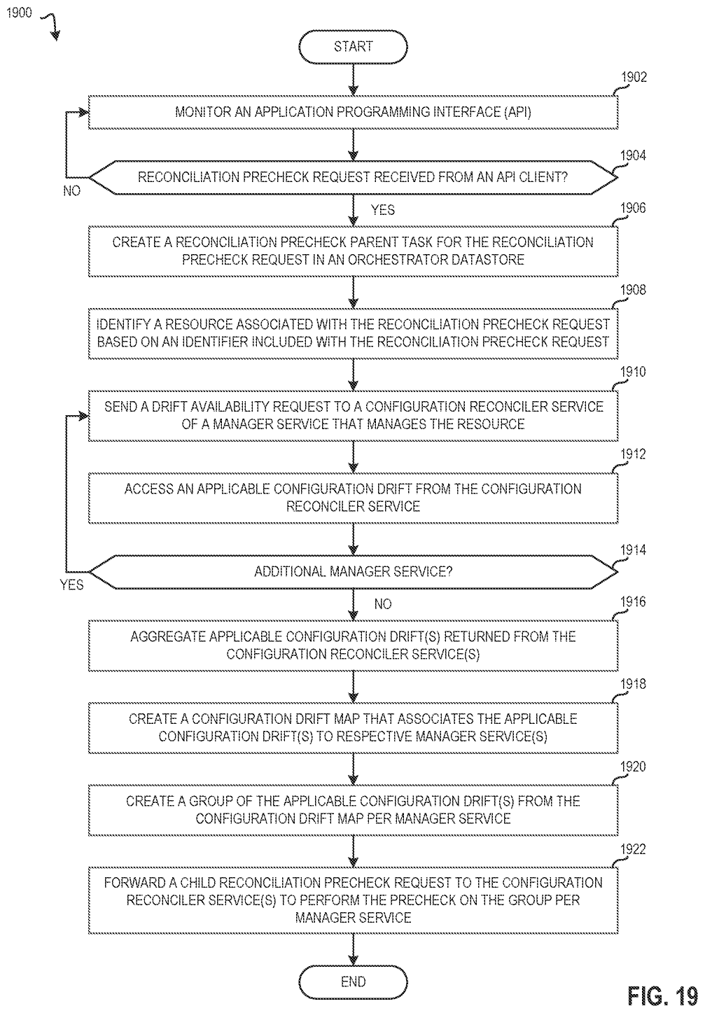

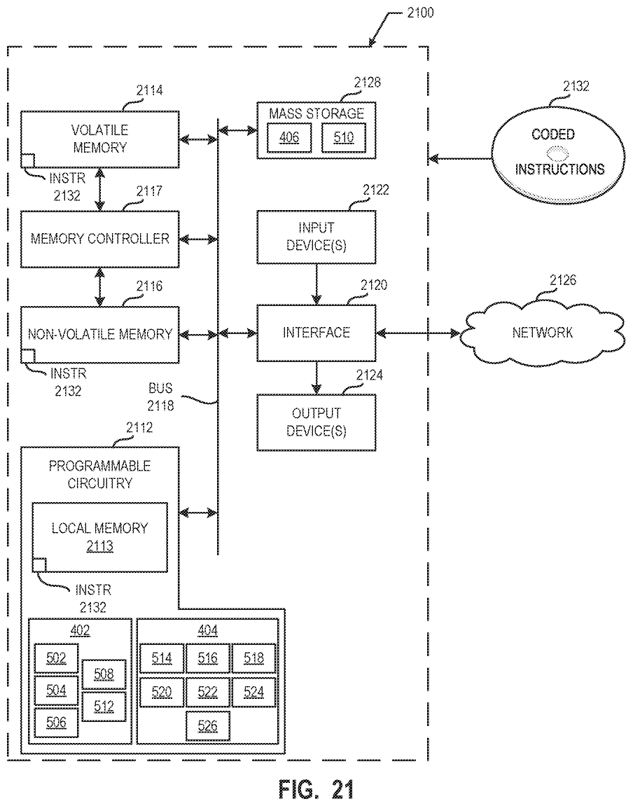

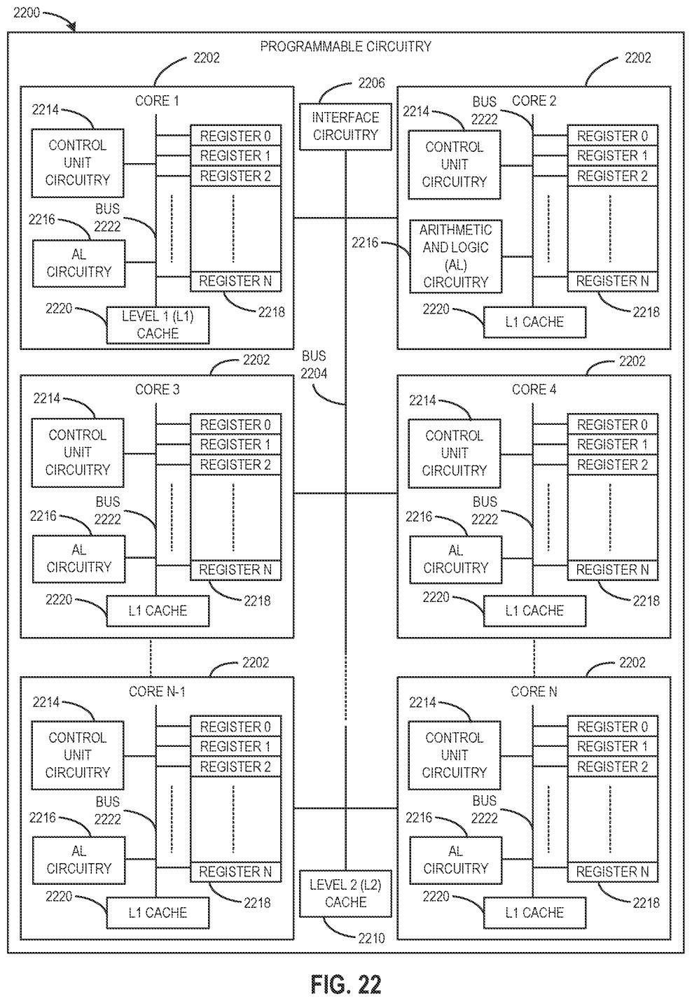

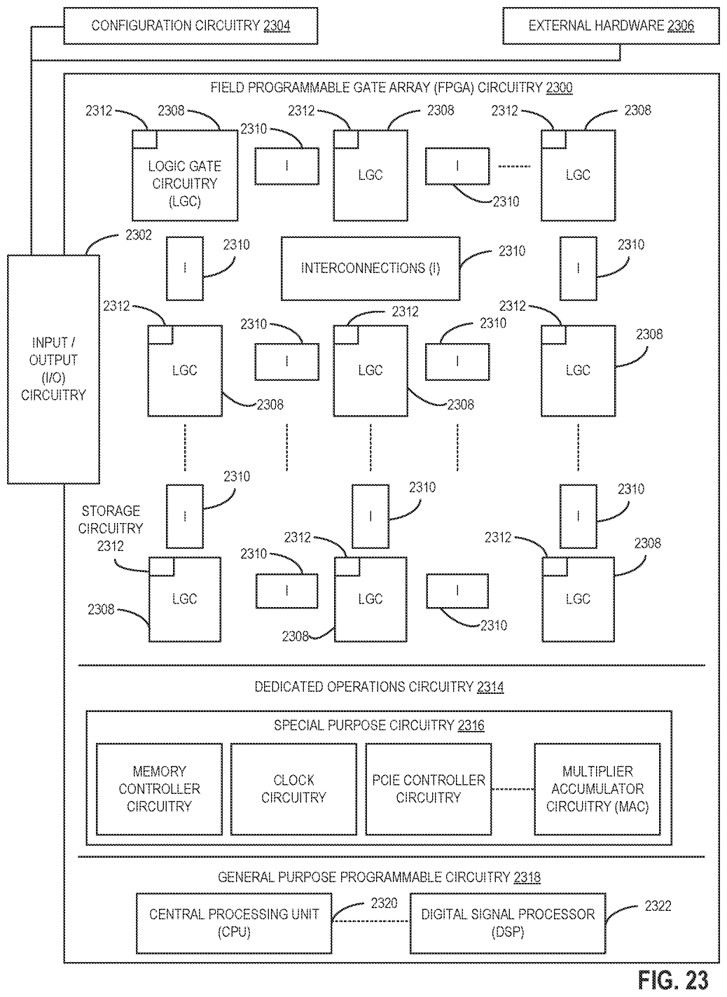

In some examples, the configuration drift reconciliation orchestrator 402 includes first means for interfacing. For example, the first means for interfacing may be implemented by API controller circuitry such as the API controller 502. In some examples, the API controller 502 may be instantiated by programmable circuitry such as the example programmable circuitry 2112 of FIG. 21. For instance, the API controller 502 may be instantiated by the example microprocessor 2200 of FIG. 22 executing machine-executable instructions such as those implemented by at least blocks 1202, 1204, and 1216 of FIG. 12, at least blocks 1502 and 1504 of FIG. 15, at least blocks 1702, 1704, and 1716 of FIG. 17, and/or at least blocks 1902 and 1904 of FIG. 19. In some examples, the API controller 502 may be instantiated by hardware logic circuitry, which may be implemented by an ASIC, XPU, or the FPGA circuitry 2300 of FIG. 23 configured and/or structured to perform operations corresponding to the machine-readable instructions. Additionally or alternatively, the API controller 502 may be instantiated by any other combination of hardware, software, and/or firmware. For example, the API controller 502 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In the illustrated example of FIG. 5, the orchestration service 504 is coupled to the API controller 502, the configuration sequence service 506, the orchestrator DAL interface 508, and the API client 512. In some examples, the orchestration service 504 is instantiated by programmable circuitry executing orchestration instructions and/or configured to perform operations such as those represented by the flowchart(s) of FIGS. 12, 15, 17, and/or 19. In the example of FIG. 5, the orchestration service 504 provides a single interface to a user and/or API clients for fetching applicable drifts and/or reconciling the applicable drifts. The orchestration service 504 serves to fetch and/or reconcile applicable drifts for resources managed by a single manager service and/or multiple manager services.

In the illustrated example of FIG. 5, the orchestration service 504 operates as a multiplexer and/or demultiplexer across different manager services of the SDDC 100 (e.g., the operations manager 110 and/or the domain manager 112), sequences reconciliation of configuration drifts to resources of the SDDC 100, and/or aggregates responses from the manager services of the SDDC 100 (e.g., the operations manager 110 and/or the domain manager 112). In the example of FIG. 5, when a user and/or API client invokes a drift availability request (e.g., via a GET /v1/config-drifts request) with query parameters to retrieve all configuration drifts for the SDDC 100, all configuration drifts for a resource of the SDDC 100, and/or all applicable configuration drifts for a resource of the SDDC 100, the orchestration service 504 relays the drift availability request to manager services registered with the orchestration service 504 that manage the resource(s) identified in the drift availability request.

In the illustrated example of FIG. 5, each manager service (e.g., the operations manager 110 and/or the domain manager 112) responds to the orchestration service 504 with the configuration drifts for the resource identified in the drift availability request. In some examples, a resource may not be managed by a manager service. In some such examples, the orchestration service 504 returns an empty response for the drift availability request. Additionally or alternatively, a resource may be jointly managed by multiple manager services. In some such examples, the orchestration service 504 aggregates the configuration drifts returned by the manager services and presents a combined response to the user and/or client that sent the drift availability request.

In the illustrated example of FIG. 5, when a user and/or API client triggers reconciliation of one or more configuration drifts (e.g., selectively or all configuration drifts) for a resource (e.g., an uber resource and/or a granular resource) by invoking a reconciliation request (e.g., via a POST /v1/config-drift-reconciliations request), the orchestration service 504 creates a parent task object in the orchestrator datastore 510 (e.g., via the orchestrator DAL interface 508) before returning the parent task object to the user and/or API client. In this manner, the user and/or API client can track the progress of the reconciliation request. In the example of FIG. 5, the orchestration service 504 forwards drift availability requests to the configuration reconciler service 404 of each manager service (e.g., the first configuration reconciler service 404_{A} and the second configuration reconciler service 404_{B}) and retrieves the applicable configuration drifts returned by the configuration reconciler service 404 of each manager service (e.g., the first configuration reconciler service 404_{A} and the second configuration reconciler service 404_{B}).

In the illustrated example of FIG. 5, the orchestration service 504 creates a configuration drift map based on the information returned from the configuration reconciler service 404 of each manager service (e.g., the first configuration reconciler service 404_{A} and the second configuration reconciler service 404_{B}). Additionally, the orchestration service 504 caches the configuration drift map. For example, the orchestration service 504 caches the configuration drift map in the orchestrator datastore 510 (e.g., via the orchestrator DAL interface 508). In the example of FIG. 5, the configuration drift map associates applicable drifts returned based on a drift availability request with respective manager services. Additionally, based on a directed acyclic graph (DAG) that sequences the applicable configuration drifts based on dependencies (e.g., hard and/or soft dependencies) between the applicable drifts, the example orchestration service 504 groups the ordered configuration drifts per manager service.

In the illustrated example of FIG. 5, if a dependent drift is not part of the applicable drifts being grouped, the orchestration service 504 validates a reason for inapplicability based on dynamically computed applicability information returned by the configuration reconciler service 404 as described below. For example, if the reason for inapplicability is determined to be historical reconciliation of the configuration drift a live check indicating the configuration drift is not applicable, dispatch of the ordered configuration drifts to the configuration reconciler service 404 proceeds. If the reason for inapplicability is that a version dependency is not satisfied, the orchestration service 504 disallows reconciliation to proceed by indicating the appropriate reason.

In the illustrated example of FIG. 5, to reconcile the configuration drifts of a configuration drift group, the orchestration service 504 forwards a single API call to the API controller 514 of the configuration reconciler service 404 of the manager service for the configuration drift group. For example, the orchestration service 504 forwards the single API call to the API controller 514 via the API client 512. Additionally, the orchestration service 504 forwards a child reconciliation request (e.g., a configuration drift group) to the configuration reconciler service 404 and registers a reconciliation child task created by the configuration reconciler service 404 in the orchestrator datastore 510 (e.g., via the orchestrator DAL interface 508) to track the reconciliation of the configuration drift group. The orchestration service 504 also polls the reconciliation child task until the reconciliation child task is completed. As such, the orchestration service 504 can track the success and/or failure to reconcile a configuration drift via the reconciliation child task registered with the orchestration datastore 510. Thus, the orchestration service 504 can invoke reconciliation of the next configuration drift group once the status polling for the previous configuration drift group reveals completion of the previous reconciliation task. Additionally, the orchestration service 504 aggregates the status of reconciliation child tasks and reports the aggregated data in the reconciliation parent task object.

In the illustrated example of FIG. 5, the orchestration service 504 also handles resource lock management. For example, depending on the resource granularity in a reconciliation request, the orchestration service 504 locks a resource (and/or component resources of an uber resource) at the beginning of a reconciliation process and releases the resource upon completion of the reconciliation process and/or upon an unplanned restart of the configuration reconciler service 404 while reconciliation was in progress. In examples disclosed herein, resource locking is not performed at the level of the configuration reconciler service 404 to avoid interruptions to the configuration reconciliation by other workflows acquiring locks in the window between reconciliation child tasks of the reconciliation parent task. In the example of FIG. 5, based on a reconciliation status request, the orchestration service 504 returns the overall status of reconciliation of configuration drifts identified in the request (e.g., and tracked by the parent task). For example, the orchestration service 504 aggregates reconciliation status records that are returned by the configuration reconciler service 404 of each manager service (e.g., the first configuration reconciler service 404_{A} and the second configuration reconciler service 404_{B}).

In some examples, the configuration drift reconciliation orchestrator 402 includes means for orchestrating. For example, the means for orchestrating may be implemented by orchestration service circuitry such as the orchestration service 504. In some examples, the orchestration service 504 may be instantiated by programmable circuitry such as the example programmable circuitry 2112 of FIG. 21. For instance, the orchestration service 504 may be instantiated by the example microprocessor 2200 of FIG. 22 executing machine-executable instructions such as those implemented by at least blocks 1206, 1212, and 1214 of FIG. 12, at least blocks 1506, 1508, 1514, 1516, 1518, and 1522 of FIG. 15, at least blocks 1706, 1712, and 1714 of FIG. 17, and/or at least blocks 1906, 1908, 1914, 1916, 1918, and 1920 of FIG. 19. In some examples, the orchestration service 504 may be instantiated by hardware logic circuitry, which may be implemented by an ASIC, XPU, or the FPGA circuitry 2300 of FIG. 23 configured and/or structured to perform operations corresponding to the machine-readable instructions. Additionally or alternatively, the orchestration service 504 may be instantiated by any other combination of hardware, software, and/or firmware. For example, the orchestration service 504 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In the illustrated example of FIG. 5, the configuration sequence service 506 is coupled to the orchestration service 504. In some examples, the configuration sequence service 506 is instantiated by programmable circuitry executing sequencing instructions and/or configured to perform operations such as those represented by the flowchart(s) of FIG. 15. In the example of FIG. 5, the configuration sequence service 506 determines a sequence according to which to reconcile configuration drifts to create a DAG in the orchestrator datastore 510 for the SDDC 100. For example, using topological sorting based on hard dependency metadata and/or soft dependency metadata present in each configuration drift, the configuration sequence service 506 creates the DAG. In the example of FIG. 5, the DAG provides an order according to which configuration drifts are to be applied per reconciliation request.

In some examples, the configuration drift reconciliation orchestrator 402 includes means for sequencing. For example, the means for sequencing may be implemented by configuration sequence service circuitry such as the configuration sequence service 506. In some examples, the configuration sequence service 506 may be instantiated by programmable circuitry such as the example programmable circuitry 2112 of FIG. 21. For instance, the configuration sequence service 506 may be instantiated by the example microprocessor 2200 of FIG. 22 executing machine-executable instructions such as those implemented by at least block 1520 of FIG. 15. In some examples, the configuration sequence service 506 may be instantiated by hardware logic circuitry, which may be implemented by an ASIC, XPU, or the FPGA circuitry 2300 of FIG. 23 configured and/or structured to perform operations corresponding to the machine-readable instructions. Additionally or alternatively, the configuration sequence service 506 may be instantiated by any other combination of hardware, software, and/or firmware. For example, the configuration sequence service 506 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In the illustrated example of FIG. 5, the orchestrator DAL interface 508 is coupled to the orchestration service 504 and the orchestrator datastore 510. In the example of FIG. 5, the orchestrator DAL interface 508 exposes a DAL of the orchestrator datastore 510 to the orchestration service 504. For example, the orchestrator DAL interface 508 provides simplified access to data stored in the orchestrator datastore 510.

In the illustrated example of FIG. 5, the orchestrator datastore 510 is coupled to the orchestrator DAL interface 508. As described above, the orchestration service 504 acts as a task aggregator for child tasks run by manager services and serves as a single reconciliation request from a user and/or API client. As such, the orchestration service 504 maintains one or more data structures (e.g., tables) in the orchestrator datastore 510. For example, the orchestrator datastore 510 includes a first data structure (e.g., a reconciliation parent task table) to store information about a reconciliation request that is being sent to the configuration drift reconciliation orchestrator 402 from an external entity (e.g., a user, an API client, etc.). Additionally, the orchestrator datastore 510 includes a second data structure (e.g., a reconciliation parent task metadata table) to store information indicative of relationships between parent tasks and child tasks across manager services. For example, child tasks are registered with the orchestration service 504 in the second data structure (e.g., a reconciliation parent task metadata table) by storing child task metadata along with a parent task identifier (ID).

In the illustrated example of FIG. 5, the orchestrator datastore 510 stores one or more data structures representative of a DAG of the SDDC 100, a configuration drift map for manager services, and/or one or more configuration drift groups. In this manner, the orchestration service 504 can provide a list of configuration drifts to the configuration reconciler service 404 of each manager service for sequential reconciliation as described above. Additionally, the orchestrator datastore 510 also stores aggregated reconciliation status records corresponding to configuration drift reconciliations. In this manner, the orchestration service 504 can access the aggregated reconciliation status records and report them to a user and/or API client. In the example of FIG. 5, the orchestrator datastore 510 may be partitioned into a cache, a database, and/or a file system. For example, the one or more data structures representative of a DAG of the SDDC 100 and a configuration drift map for manager services are stored in a portion of the orchestrator datastore 510 that corresponds to (e.g., is reserved for) a cache of the orchestration service 504. Additionally, a database portion of the orchestrator datastore 510 may be implemented as a PostgreSQL database.

In the illustrated example of FIG. 5, the orchestrator datastore 510 may be implemented by a volatile memory (e.g., a SDRAM, DRAM, RDRAM, etc.) and/or a non-volatile memory (e.g., flash memory). The orchestrator datastore 510 may additionally or alternatively be implemented by one or more DDR memories, such as DDR, DDR2, DDR3, DDR4, DDR5, mDDR, DDR SDRAM, etc. The orchestrator datastore 510 may additionally or alternatively be implemented by one or more mass storage devices such as HDD(s), CD drive(s), DVD drive(s), SSD drive(s), SD card(s), CF card(s), etc. While in the illustrated example the orchestrator datastore 510 is illustrated as a single datastore, the orchestrator datastore 510 may be implemented by any number and/or type(s) of datastores. Furthermore, the data stored in the orchestrator datastore 510 may be in any data format such as, for example, binary data, comma delimited data, tab delimited data, SQL structures, etc.

In the illustrated example of FIG. 5, the API client 512 is coupled to the orchestration service 504 and the configuration reconciler service 404 of each manager service (e.g., the first configuration reconciler service 404_{A} and the second configuration reconciler service 404_{B}). In some examples, the API client 512 is instantiated by programmable circuitry executing API instructions and/or configured to perform operations such as those represented by the flowchart(s) of FIGS. 12, 15, 17, and 19. In the example of FIG. 5, the API client 512 exposes an API client of the configuration drift reconciliation orchestrator 402 to the configuration reconciler service 404. For example, the API client 512 is a REST API client to a REST API exposed by the configuration reconciler service 404. In the example of FIG. 5, the API client 512 can be used by the orchestration service 504 to fetch reconciliation status records of configuration drift reconciliations from the configuration reconciler service 404.

In some examples, the configuration drift reconciliation orchestrator 402 includes second means for interfacing. For example, the second means for interfacing may be implemented by API client circuitry such as the API client 512. In some examples, the API client 512 may be instantiated by programmable circuitry such as the example programmable circuitry 2112 of FIG. 21. For instance, the API client 512 may be instantiated by the example microprocessor 2200 of FIG. 22 executing machine-executable instructions such as those implemented by at least blocks 1208 and 1210 of FIG. 12, at least blocks 1510, 1512, and 1524 of FIG. 15, at least blocks 1708 and 1710 of FIG. 17, and/or at least blocks 1910, 1912, and 1922 of FIG. 19. In some examples, the API client 512 may be instantiated by hardware logic circuitry, which may be implemented by an ASIC, XPU, or the FPGA circuitry 2300 of FIG. 23 configured and/or structured to perform operations corresponding to the machine-readable instructions. Additionally or alternatively, the API client 512 may be instantiated by any other combination of hardware, software, and/or firmware. For example, the API client 512 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In the illustrated example of FIG. 5, the configuration reconciler service 404 is implemented as library including machine readable instructions to implement the configuration datastore 406, the API controller 514, the drift detector service 516, the resource mapping service 518, the applicability service 520, the reconciliation FSM service 522, the configuration reconciler service DAL interface 524, and the governance service 526. As such, a manager service can access the library to implement the configuration reconciler service 404. In the example of FIG. 5, when implemented, one or more of the configuration datastore 406, the API controller 514, the drift detector service 516, the resource mapping service 518, the applicability service 520, the reconciliation FSM service 522, the configuration reconciler service DAL interface 524, or the governance service 526 may be instantiated (e.g., creating an instance of, bring into being for any length of time, materialize, implement, etc.) by programmable circuitry such as a Central Processor Unit (CPU) executing first instructions. Additionally or alternatively, one or more of the configuration datastore 406, the API controller 514, the drift detector service 516, the resource mapping service 518, the applicability service 520, the reconciliation FSM service 522, the configuration reconciler service DAL interface 524, or the governance service 526 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 5 may, thus, be instantiated at the same or different times. Some or all of the circuitry of FIG. 5 may be instantiated, for example, in one or more threads executing concurrently on hardware and/or in series on hardware. Moreover, in some examples, some or all of the circuitry of FIG. 5 may be implemented by microprocessor circuitry executing instructions and/or FPGA circuitry performing operations to implement one or more virtual machines and/or containers.

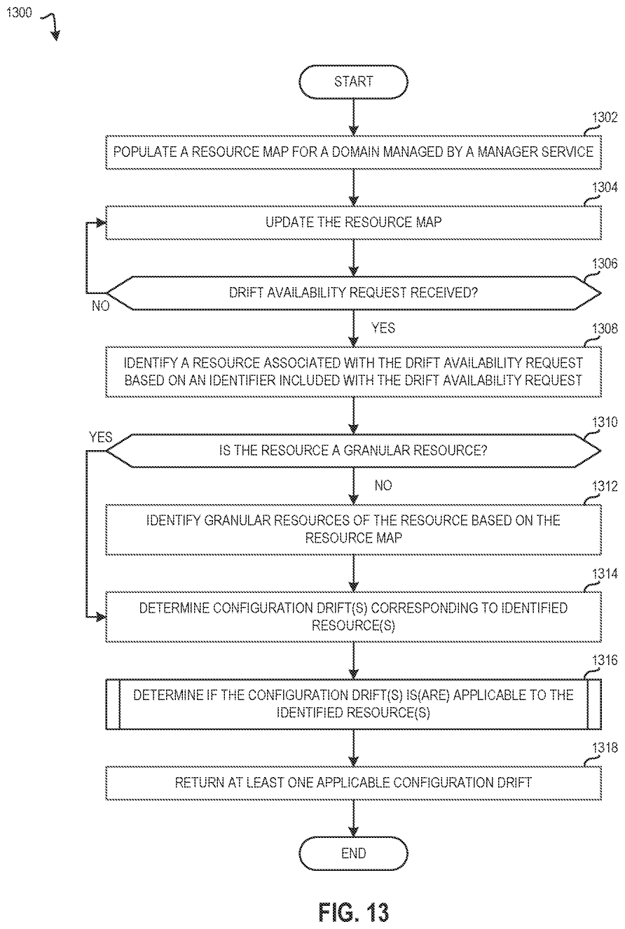

In the illustrated example of FIG. 5, the API controller 514 is coupled to the configuration datastore 406, the API client 512, the drift detector service 516, the resource mapping service 518, the applicability service 520, the reconciliation FSM service 522, the configuration reconciler service DAL interface 524, and the governance service 526. In some examples, the API controller 514 is instantiated by programmable circuitry executing API instructions and/or configured to perform operations such as those represented by the flowchart(s) of FIGS. 13, 16, 18, and 20. In the example of FIG. 5, the API controller 514 exposes a REST API that handles communication with the configuration drift reconciliation orchestrator 402.

For example, the API controller 514 responds to a drift availability request (e.g., made via a GET API/localhost/{service}/config-drifts request) with query parameters to fetch configuration drifts managed by the manager service associated with the configuration reconciler service 404. Additionally, the API controller 514 responds to a child reconciliation request (e.g., made via a POST API/localhost/{service}/config-drift-reconciliations request) to allow a user and/or API client to request reconciliation of one or more configuration drifts with a single inter-process communication (IPC). The example child reconciliation request allows for each configuration drift to be reconciled with one or more granular resources or an uber resource (e.g., a domain).

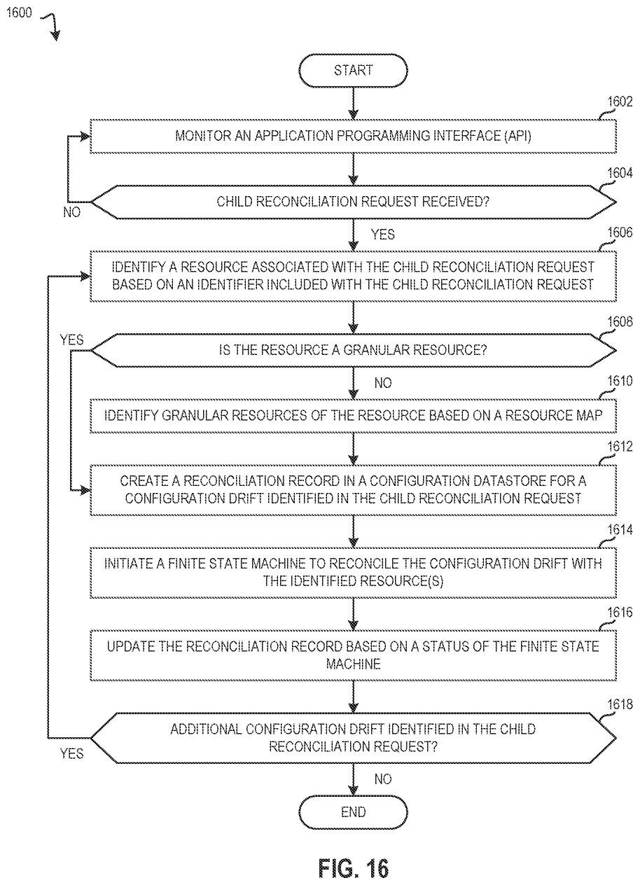

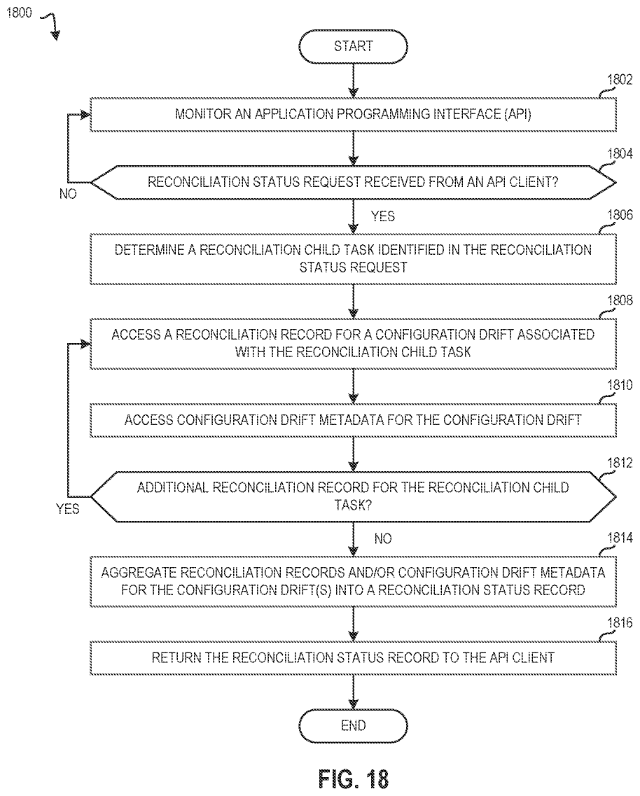

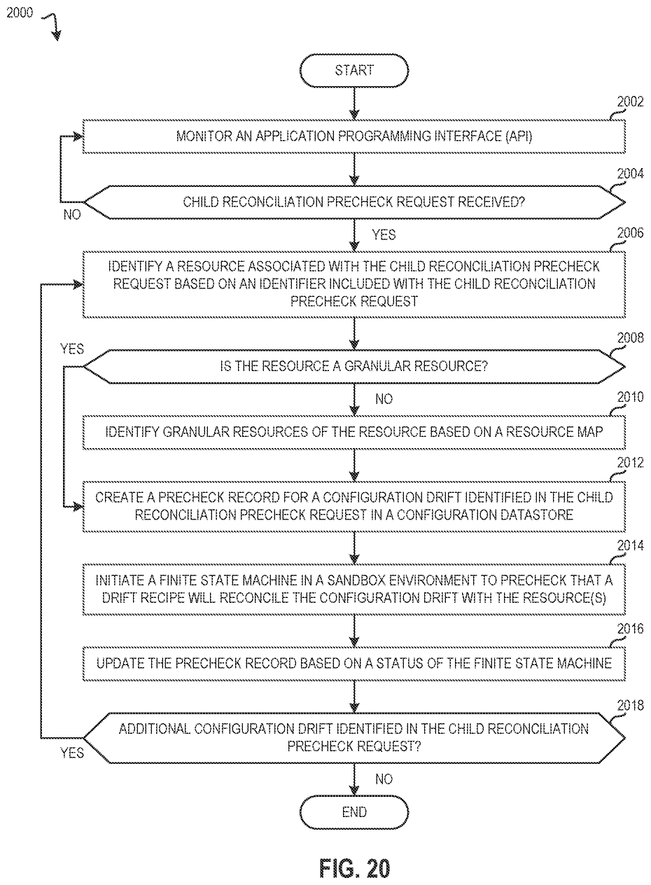

In some examples, the configuration reconciler service 404 includes first means for interfacing. For example, the first means for interfacing may be implemented by API controller circuitry such as the API controller 514. In some examples, the API controller 514 may be instantiated by programmable circuitry such as the example programmable circuitry 2112 of FIG. 21. For instance, the API controller 514 may be instantiated by the example microprocessor 2200 of FIG. 22 executing machine-executable instructions such as those implemented by at least blocks 1306 and 1318 of FIG. 13, at least blocks 1602 and 1604 of FIG. 16, at least blocks 1802, 1804, and 1816 of FIG. 18, and/or at least blocks 2002 and 2004 of FIG. 20. In some examples, the API controller 514 may be instantiated by hardware logic circuitry, which may be implemented by an ASIC, XPU, or the FPGA circuitry 2300 of FIG. 23 configured and/or structured to perform operations corresponding to the machine-readable instructions. Additionally or alternatively, the API controller 514 may be instantiated by any other combination of hardware, software, and/or firmware. For example, the API controller 514 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In the illustrated example of FIG. 5, the drift detector service 516 is coupled to the configuration datastore 406, the API controller 514, the resource mapping service 518, the applicability service 520, the reconciliation FSM service 522, the configuration reconciler service DAL interface 524, and the governance service 526. In some examples, the drift detector service 516 is instantiated by programmable circuitry executing drift detection instructions and/or configured to perform operations such as those represented by the flowchart(s) of FIG. 13. In the example of FIG. 5, the drift detector service 516 fetches and/or filters configuration drift metadata from the configuration datastore 406 to present in the API controller 514. In some examples, the drift detector service 516 includes adapters to change the configuration drift metadata to the appropriate processing layer of the SDDC manager 102. In the example of FIG. 5, if no query parameters are specified in a drift availability request (e.g., made via a GET API/localhost/{service}/config-drifts request), the list of drifts detected by the drift detector service 516 is returned as is (e.g., without change relative to the state of the list before the drift availability request).

In some examples, the configuration reconciler service 404 includes means for detecting configuration drift. For example, the means for detecting configuration drift may be implemented by drift detector service circuitry such as the drift detector service 516. In some examples, the drift detector service 516 may be instantiated by programmable circuitry such as the example programmable circuitry 2112 of FIG. 21. For instance, the drift detector service 516 may be instantiated by the example microprocessor 2200 of FIG. 22 executing machine-executable instructions such as those implemented by at least blocks 1308, 1310, 1312, and 1314 of FIG. 13. In some examples, the drift detector service 516 may be instantiated by hardware logic circuitry, which may be implemented by an ASIC, XPU, or the FPGA circuitry 2300 of FIG. 23 configured and/or structured to perform operations corresponding to the machine-readable instructions. Additionally or alternatively, the drift detector service 516 may be instantiated by any other combination of hardware, software, and/or firmware. For example, the drift detector service 516 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In the illustrated example of FIG. 5, the resource mapping service 518 is coupled to the configuration datastore 406, the API controller 514, the drift detector service 516, the applicability service 520, the reconciliation FSM service 522, the configuration reconciler service DAL interface 524, and the governance service 526. In some examples, the resource mapping service 518 is instantiated by programmable circuitry executing resource mapping instructions and/or configured to perform operations such as those represented by the flowchart(s) of FIG. 13. As described above, in some examples, a resource to which a configuration drift is applicable may be an uber resource or a granular resource. As used herein, a granular resource refers to a resource of the SDDC 100 without any child resources. As used herein, an uber resource refers to a resource of the SDDC 100 that includes two or more child resources. In some examples, an uber resource of the SDDC 100 may include two or more uber resources of the SDDC 100 which themselves include two or more granular resources.

In the illustrated example of FIG. 5, to support reconciliation of a configuration drift with an uber resource (which includes two or more granular resources (e.g., child resources) to which the configuration drift is applicable), the configuration reconciler service 404 identifies the component resources (e.g., child resources) of the uber resource. To do so, the resource mapping service 518 constructs an example resource map 528 to map a resource hierarchy of the SDDC 100. For example, the resource mapping service 518 maps the SDDC resource hierarchy at startup of the configuration reconciler service 404 and periodically updates the resource map 528 to accommodate a new resource added to the SDDC 100, a version change in a product associated with a resource of the SDDC 100, and/or a change to an applicable configuration drift based on a live configuration check.

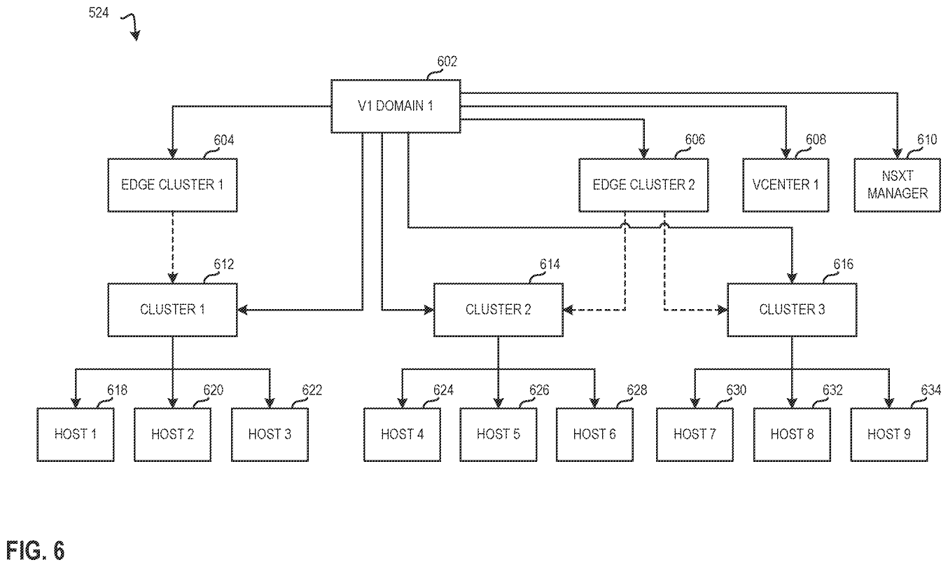

FIG. 6 is an illustration of the example resource map 528 that may be generated by the example resource mapping service 518 of FIG. 5. In the example of FIG. 6, the resource map 528 maps a management domain 602 of the SDDC 100. The example management domain 602 is an uber resource that includes an example first edge cluster 604, an example second edge cluster 606, an example VMware vCenter® virtual infrastructure server instance 608, an example VMware NSX® network virtualization manager instance 610, an example first cluster 612, an example second cluster 614, and an example third cluster 616.

In the illustrated example of FIG. 6, the first edge cluster 604 is an uber resource that includes the first cluster 612. The first cluster 612 is a group of host devices including an example first host device 618 (e.g., a physical machine), an example second host device 620 (e.g., a physical machine), and an example third host device 622 (e.g., a physical machine). In the example of FIG. 6, the second edge cluster 606 is an uber resource that includes the second cluster 614 and the third cluster 616. In the example of FIG. 6, the second cluster 614 is a group of host devices including an example fourth host device 624 (e.g., a physical machine), an example fifth host device 626 (e.g., a physical machine), and an example sixth host device 628 (e.g., a physical machine).

In the illustrated example of FIG. 6, the third cluster 616 is a group of host devices including an example seventh host device 630 (e.g., a physical machine), an example eighth host device 632 (e.g., a physical machine), and an example ninth host device 634 (e.g., a physical machine). In the example of FIG. 6, each resource identified in the resource map 528 is represented by a node that includes one or more data fields. In the example of FIG. 6, a node of the resource map 528 includes a first data field indicative of a parent node, a second data field indicative of an ID of the node, a third data field indicative of a resource type of the node, a fourth data field indicative of a domain ID of the management domain 602, and a fifth data field indicative of whether a configuration drift reconciliation is pending (e.g., yet to be reconciled with the resource).

Returning to FIG. 5, in some examples, the configuration reconciler service 404 includes means for mapping. For example, the means for mapping may be implemented by resource mapping service circuitry such as the resource mapping service 518. In some examples, the resource mapping service 518 may be instantiated by programmable circuitry such as the example programmable circuitry 2112 of FIG. 21. For instance, the resource mapping service 518 may be instantiated by the example microprocessor 2200 of FIG. 22 executing machine-executable instructions such as those implemented by at least blocks 1302 and 1304 of FIG. 13. In some examples, the resource mapping service 518 may be instantiated by hardware logic circuitry, which may be implemented by an ASIC, XPU, or the FPGA circuitry 2300 of FIG. 23 configured and/or structured to perform operations corresponding to the machine-readable instructions. Additionally or alternatively, the resource mapping service 518 may be instantiated by any other combination of hardware, software, and/or firmware. For example, the resource mapping service 518 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

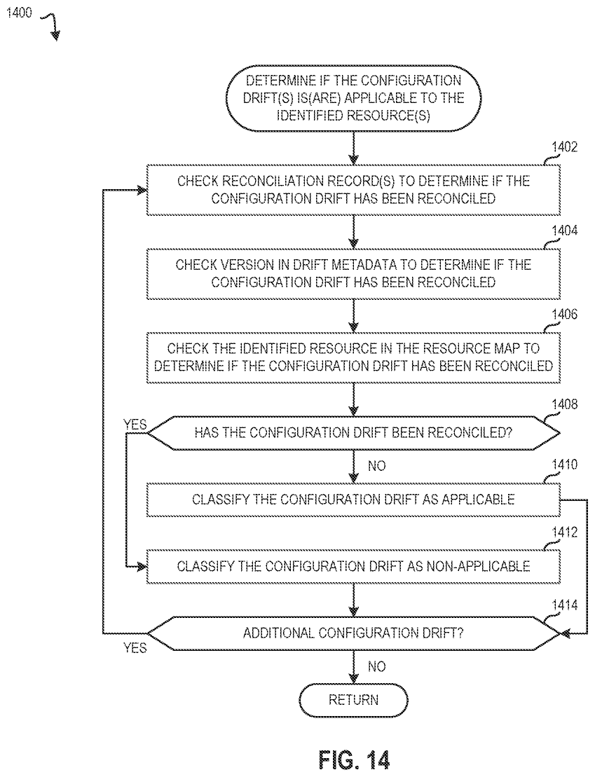

In the illustrated example of FIG. 5, the applicability service 520 is coupled to the configuration datastore 406, the API controller 514, the drift detector service 516, the resource mapping service 518, the reconciliation FSM service 522, the configuration reconciler service DAL interface 524, and the governance service 526. In some examples, the applicability service 520 is instantiated by programmable circuitry executing configuration drift applicability determination instructions and/or configured to perform operations such as those represented by the flowchart(s) of FIGS. 13 and 14. In the example of FIG. 5, the applicability service 520 filters the drifts detected by the drift detector service 516 based on applicability criteria. For example, the applicability service 520 determines the applicability of a configuration drift on uber resources and/or granular resources. In some examples, a configuration drift is considered applicable to an uber resource if the configuration drift is applicable to at least one child resource of the uber resource.

In the illustrated example of FIG. 5, the applicability service 520 determines the applicability of a configuration drift to a resource based on a check of one or more example reconciliation records 530, a version check based on configuration drift metadata, and/or a live check of the resource map 528. For example, each of the one or more reconciliation records 530 is a data structure that represents a one-to-one-to-one relationship between a reconciliation child task, a configuration drift associated with the reconciliation child task, and a granular resource. By checking the one or more reconciliation records 530, the applicability service 520 determines whether a configuration drift has been applied to a resource.

In the illustrated example of FIG. 5, by checking a version based on the configuration drift metadata, the applicability service 520 determines whether a version identified in the configuration drift metadata matches a version of a product running on a resource of the SDDC 100 that corresponds to the configuration drift. If the version identified in the configuration drift metadata does not match the version of the product running on the resource, the applicability service 520 determines that the configuration drift is applicable to the resource. Alternatively, if the version identified in the configuration drift metadata matches the version of the product running on the resource, the applicability service 520 determines that the configuration drift is not applicable to the resource.

In the illustrated example of FIG. 5, by performing the live check of the resource map 528, the applicability service 520 determines if a data field (e.g., a present status field) of a node corresponding to the resource indicates that a configuration drift reconciliation is pending (e.g., a configuration drift has yet to be reconciled with the resource). If the data field of the node corresponding to the resource indicates that a configuration drift reconciliation is pending, the applicability service 520 determines that the configuration drift is applicable to the resource. Alternatively, if the data field of the node corresponding to the resource does not indicate that a configuration drift reconciliation is pending, the applicability service 520 determines that the configuration drift is not applicable to the resource.

For example, for a brownfield resource, the data field of the node corresponding to the resource will indicate that the configuration drift has been realized for the resource. As such, the applicability service 520 can distinguish between brownfield resources and greenfield resources. Even if a configuration drift has not been applied to a resource through the SDDC manager 102 and the version identified in the configuration drift metadata does not match the version of a product running on the resource, the applicability service 520 will still determine that the configuration drift is not applicable to the resource if the data field of the node corresponding to the resource indicates that the configuration drift has been realized for the resource.

In the illustrated example of FIG. 5, as described above, the applicability service 520 computes a dynamic applicability status for an available configuration drift. After determining a dynamic applicability status, the applicability service 520 returns the dynamic applicability status to the orchestration service 504. An example dynamic applicability status indicates a reason for a configuration drift being found inapplicable to a resource. In addition to a dynamic applicability status, the applicability service 520 returns static metadata related to a configuration drift to the orchestration service 504. As described above, the orchestration service 504 utilizes the dynamic applicability status to determine if a dependent configuration drift has been historically reconciled.

In some examples, the configuration reconciler service 404 includes means for determining applicability. For example, the means for determining applicability may be implemented by applicability service circuitry such as the applicability service 520. In some examples, the applicability service 520 may be instantiated by programmable circuitry such as the example programmable circuitry 2112 of FIG. 21. For instance, the applicability service 520 may be instantiated by the example microprocessor 2200 of FIG. 22 executing machine-executable instructions such as those implemented by at least block 1316 of FIG. 13 and/or at least blocks 1402, 1404, 1406, 1408, 1410, 1412, and 1414 of FIG. 14. In some examples, the applicability service 520 may be instantiated by hardware logic circuitry, which may be implemented by an ASIC, XPU, or the FPGA circuitry 2300 of FIG. 23 configured and/or structured to perform operations corresponding to the machine-readable instructions. Additionally or alternatively, the applicability service 520 may be instantiated by any other combination of hardware, software, and/or firmware. For example, the applicability service 520 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In the illustrated example of FIG. 5, the reconciliation FSM service 522 is coupled to the configuration datastore 406, the API controller 514, the drift detector service 516, the resource mapping service 518, the applicability service 520, the configuration reconciler service DAL interface 524, and the governance service 526. In some examples, the reconciliation FSM service 522 is instantiated by programmable circuitry executing reconciliation instructions and/or configured to perform operations such as those represented by the flowchart(s) of FIGS. 16, 18, and 20. In the example of FIG. 5, the reconciliation FSM service 522 responds to a child reconciliation request. For example, the reconciliation FSM service 522 performs a reconciliation child task (e.g., created by the API controller 514) for each configuration drift identified in the child reconciliation request (e.g., configuration drift group) and initiates one or more FSM workflows to reconcile a configuration drift with a resource.

As described above, the orchestration service 504 provides a configuration drift group to the configuration reconciler service 404 as a child reconciliation request. The configuration drift group is to be sequentially reconciled with one or more resources of the SDDC 100. For example, the orchestration service 504 provides the configuration drift group to the configuration reconciler service 404 via single child reconciliation request (e.g., made via a single POST API/localhost/{service}/config-drift-reconciliations request). Based on such a child reconciliation request, the reconciliation FSM service 522 implements a single FSM workflow to reconcile multiple configuration drifts. For example, based on a child reconciliation request, the reconciliation FSM service 522 identifies a resource associated with the child reconciliation request based on a resource ID included with the child reconciliation request. Additionally, for example, based on the child reconciliation request, the reconciliation FSM service 522 identifies an FSM corresponding to the configuration drift (e.g., updated configuration) based on a drift ID included with the child reconciliation request. The reconciliation FSM service 522 then executes the FSM to reconcile the updated configuration with the resource.

In the illustrated example of FIG. 5, the reconciliation FSM service 522 provides a status for individual configuration drift reconciliation processes based on a reconciliation status request (e.g., made via a GET/localhost/{service}/config-drift-reconciliations?taskId=<taskId> request). In the example of FIG. 5, the reconciliation FSM service 522 provides an aggregate reconciliation status for the individual configuration drifts to be reconciled based on a reconciliation child task. For example, the reconciliation FSM service 522 accesses one or more reconciliation records stored in the configuration datastore 406 and identifiable by a data tuple including a configuration drift ID and a task ID. In the example of FIG. 5, a configuration reconciliation task may be in four states: an initiated state, an in-progress state, a completed with success state, and/or a completed with failure state.

In some examples, the configuration reconciler service 404 includes means for reconciling. For example, the means for reconciling may be implemented by reconciliation FSM service circuitry such as the reconciliation FSM service 522. In some examples, the reconciliation FSM service 522 may be instantiated by programmable circuitry such as the example programmable circuitry 2112 of FIG. 21. For instance, the reconciliation FSM service 522 may be instantiated by the example microprocessor 2200 of FIG. 22 executing machine-executable instructions such as those implemented by at least blocks 1606, 1608, 1610, 1612, 1614, 1616, and 1618 of FIG. 16, at least blocks 1806, 1808, 1810, 1812, and 1814 of FIG. 18, and/or at least blocks 2006, 2008, 2010, 2012, 2014, 2016, and 2018 of FIG. 20. In some examples, the reconciliation FSM service 522 may be instantiated by hardware logic circuitry, which may be implemented by an ASIC, XPU, or the FPGA circuitry 2300 of FIG. 23 configured and/or structured to perform operations corresponding to the machine-readable instructions. Additionally or alternatively, the reconciliation FSM service 522 may be instantiated by any other combination of hardware, software, and/or firmware. For example, the reconciliation FSM service 522 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In the illustrated example of FIG. 5, the configuration reconciler service DAL interface 524 is coupled to the configuration datastore 406, the API controller 514, the drift detector service 516, the resource mapping service 518, the applicability service 520, the reconciliation FSM service 522, and the governance service 526. In the example of FIG. 5, the configuration reconciler service DAL interface 524 exposes a DAL of the configuration datastore 406 to the API controller 514, the drift detector service 516, the resource mapping service 518, the applicability service 520, the reconciliation FSM service 522, and the governance service 526. For example, the configuration reconciler service DAL interface 524 provides simplified access to data stored in the configuration datastore 406 (e.g., the one or more reconciliation records 530).

In the illustrated example of FIG. 5, the governance service 526 is coupled to the configuration datastore 406, the API controller 514, the drift detector service 516, the resource mapping service 518, the applicability service 520, the reconciliation FSM service 522, and the configuration reconciler service DAL interface 524. In the example of FIG. 5, the governance service 526 can be used to validate configuration metadata syntax and the presence of data fields consumed by the configuration reconciler service 404. For example, the governance service 526 can deserialize configuration drift metadata into a DriftMetadata object and check the DriftMetadata object.

In the illustrated example of FIG. 5, the governance service 526 will fail to validate configuration drift metadata if the configuration drift metadata does not share the same name as a corresponding parent recipe that defines the reconciliation task workflow associated with the configuration drift metadata. Additionally, the governance service 526 will fail to validate configuration drift metadata if the configuration drift ID of the configuration drift metadata is not globally unique. In the example of FIG. 5, the governance service 526 will fail to validate newly added configuration drift metadata if the configuration drift metadata declares a dependency on a previously added configuration drift other than when there is a hard dependency between the newly added configuration drift and the previously added configuration drift. Additionally, the governance service 526 will fail to validate cookbooks and/or recipes if the cookbooks and/or recipes do not deserialize and resolve correctly. In this manner, the governance service 526 allows the configuration reconciler service 404 to reduce the likelihood of a runtime failure due to an error in defining configuration drift metadata, recipes, and/or cookbooks.

In the illustrated example of FIG. 5, the configuration datastore 406 is partitioned into an example cache 406₁, an example database 406₂, and an example file system 406₃. In the example of FIG. 5, the cache 406₁ includes the example resource map 528. Additionally, the example database 406₂ includes the example one or more reconciliation records 530. In the example of FIG. 5, the file system 406₃ includes configuration drift metadata, recipes, and/or cookbooks corresponding to the manager service with which the configuration datastore 406 is associated. For example, for the first configuration datastore 406_{A}, the file system 406₃ includes example domain manager configuration drift metadata, recipes, and/or cookbooks 532_{A}. Additionally, for example, for the second configuration datastore 406_{B}, the file system 406₃ includes example operations manager configuration drift metadata, recipes, and/or cookbooks 532_{B}. In the example of FIG. 5, the cache 406₁ and the file system 406₃ are independently accessibly by the API controller 514, the drift detector service 516, the resource mapping service 518, the applicability service 520, the reconciliation FSM service 522, and the governance service 526. Additionally, the database 406₂ is accessible by the API controller 514, the drift detector service 516, the resource mapping service 518, the applicability service 520, the reconciliation FSM service 522, and the governance service 526 via the configuration reconciler service DAL interface 524.

In the illustrated example of FIG. 5, the example resource map 528 maps a resource hierarchy of the SDDC 100 as described above. Additionally, as described above, each of the example one or more reconciliation records 530 is a data structure that represents a one-to-one-to-one relationship between a reconciliation child task, a configuration drift associated with the reconciliation child task, and a granular resource. As described above, the configuration datastore 406 maintains configuration drift metadata, recipes, and/or cookbooks corresponding to the manager service with which the configuration datastore 406 is associated. In the example of FIG. 5, configuration drift metadata provides a one-to-one mapping between the configuration drift metadata and associated configuration drift reconciliation operations that are defined in one or more drift recipes. Example configuration drift metadata is illustrated below in Table 1.

TABLE 1

| | |
|---|---|
| 1. | { |
| 2. | “id”: “27d1061c-1388-11ed-861d-0242ac120002”, |
| 3. | “resourceType”: “CLUSTER”, |
| 4. | “driftType”: “feature”, |
| 5. | “applicability”: { |
| 6. | “minSddcManagerVersion”: “3.11.0.1”, |
| 7. | “maxSddcManagerVersion”: “5.1.0.0”, |
| 8. | “minVcVersion”: “7.0.3”, |
| 9. | “maxVcVersion”: “9.0.3.00500”. |
| 10. | “minNsxtVersion”: “2.5.2.2.0”, |
| 11. | “maxNsxtVersion”: “4.1.1.1.0”, |
| 12. | “minEsxiVersion”: “6.7.0”, |
| 13. | “maxEsxiVersion”: “8.0.5” |
| 14. | }, |
| 15. | “introducedIn”:”5.1.0.0”, |
| 16. | “dependsOn”:[ ] |
| 17. | } |

In the illustrated example of FIG. 5, line 2 of the example configuration metadata of Table 1 above includes an ID field (e.g., “id”). The example ID field includes an example universally unique identifier (UUID) represented as a string (e.g., “27d1061c-1388-11ed-861d-0242ac120002”). In the example of FIG. 5, the ID field is a user-generated field that includes a permanent UUID that is used to define a configuration drift. In the example of FIG. 5, the ID field is globally unique among configuration drifts.

In the illustrated example of FIG. 5, line 3 of the example configuration metadata of Table 1 above includes a resource type field (e.g., “resourceType”). The example resource type field includes a string or enumerated value (e.g., “CLUSTER”). In the example of FIG. 5, the resource type field identifies the type of resource (e.g., host, cluster, domain, edge cluster, etc.) with which the configuration drift is to be reconciled. In the example of FIG. 5, line 4 of the example configuration metadata of Table 1 above includes a configuration drift type field (e.g., “driftType”). The example configuration drift type field includes a string or enumerated value (e.g., “feature”). In the example of FIG. 5, the configuration drift type field identifies whether a configuration drift is associated with an update to a feature or a fix to an existing deployment (e.g., to patch a bug).

In the illustrated example of FIG. 5, lines 5-13 of the example configuration metadata of Table 1 above include an applicability field (e.g., “applicability”) that identifies versions of product in which the configuration drift is to become available and/or unavailable. In the example of FIG. 5, if a configuration drift is introduced in a given release, the author of the configuration drift will add the version of the release to the applicability field. If there are additional releases to which the configuration drift is applicable (e.g., if the configuration drift should be applied only after a product reaches a certain version), then the author of the configuration drift will specify the releases to which the configuration drift applies in the applicability field.

In the illustrated example of FIG. 5, example maximum sub-fields (e.g., “maxSddcManagerVersion,” etc.) of the applicability field indicate the latest versions of corresponding products to which a configuration drift is applicable. Additionally, example minimum sub-fields (e.g., “minSddcManagerVersion,” etc.) of the applicability field indicate the earliest versions of corresponding products to which a configuration drift is applicable. In the example of FIG. 5, line 15 of the example configuration metadata of Table 1 above includes an introduction field (e.g., “introducedIn”). The example introduction field includes a string value (e.g., “5.1.0.0”) that identifies the version in which a configuration drift was introduced. As such, the orchestration service 504 and/or the configuration sequence service 506 can utilize the introduction field to order configuration the reconciliation of configuration drifts sequentially across releases. For example, the introduction field can be indicative of a soft dependency of a configuration drift. As used herein, a soft dependency between a first configuration drift and a second configuration drift refers to a relationship between the first configuration drift and the second configuration drift that may require the second configuration drift to be reconciled before the first configuration drift (e.g., the first configuration drift was introduced after the second configuration drift (as indicated by the introduction field) which may require the second configuration drift to be reconciled before the first configuration drift). In the example of FIG. 5, the orchestration service 504 and/or the configuration sequence service 506 can utilize the introduction field to collate configuration drifts in a release together if managed by the same manager service.

In the illustrated example of FIG. 5, line 16 of the example configuration metadata of Table 1 above includes a dependency field (e.g., “dependsOn”). The example dependency field may include an example UUID represented as a string value. In the example of FIG. 5, the dependency field identifies a list of configuration drifts (e.g., identified by UUIDs) upon which the configuration drift has a hard dependency. As used herein, a hard dependency between a first configuration drift and a second configuration drift refers to a relationship between the first configuration drift and the second configuration drift that requires the second configuration drift to be reconciled before the first configuration drift (e.g., the first configuration drift has a hard dependency on the second configuration drift).

In examples disclosed herein, feature updates and fixes to existing deployments are typically introduced in different day-N workflows and are independent of each other in a release. As such, corresponding configuration drifts should also be independent and not configuration drift aware (e.g., depending on other configuration drifts). Accordingly, an author of a configuration drift should add a dependency if there is a known dependency between two configuration drifts (e.g., those configuration drifts associated with a feature but managed by different manager services or across releases and associated with a specific configuration). For example, the first configuration drift introduced will not have any dependencies. As such, the dependency field will be empty. As described above, the configuration sequence service 506 utilizes the data in the dependency field to create a DAG across any number of manager services that declare configuration drifts for a resource. In some examples, multiple configuration drifts on the same resource may be reconciled in parallel.

In the illustrated example of FIG. 5, the configuration datastore 406 also includes drift recipes. In the example of FIG. 5, a configuration drift recipe refers to a configuration to be performed to reconcile a configuration drift with a resource. In examples disclosed herein, each drift recipe corresponds to the operations to be performed to reconcile one configuration drift. In additional or alternative examples, a drift recipe may include operations to reconcile more than one configuration drift. For example, a drift recipe for an uber resource may include more than one child drift recipes. In the example of FIG. 5, the configuration datastore 406 also includes drift cookbooks. A drift cookbook refers to a collection of two or more drift recipes.

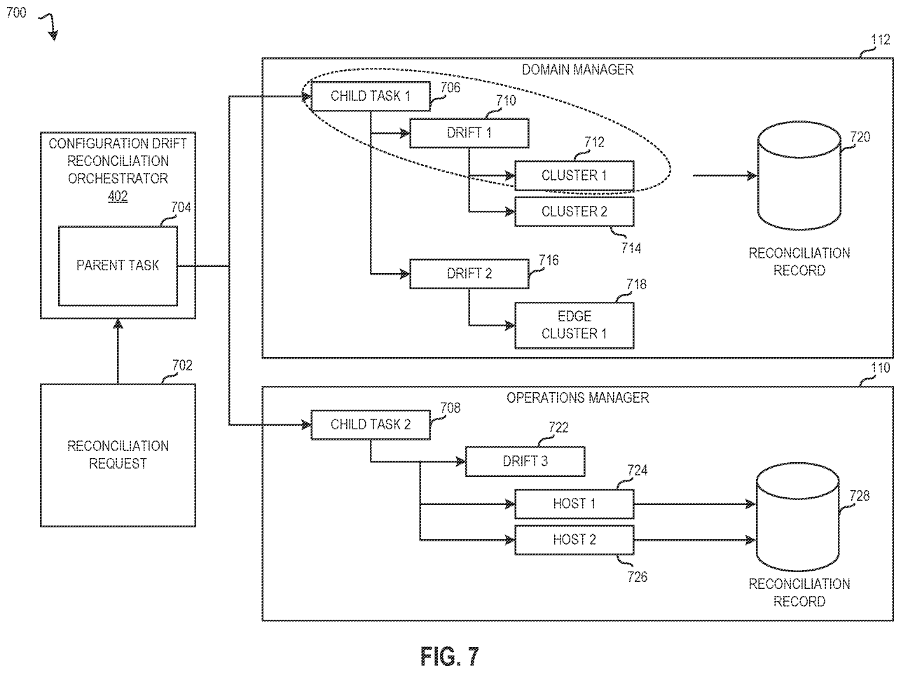

FIG. 7 is a block diagram 700 illustrating example performance of an example reconciliation request 702. In the example of FIG. 7, the reconciliation request 702 corresponds to a request to reconcile one or more configuration drifts with an uber resource managed by the domain manager 112. Based on the reconciliation request 702, the configuration drift reconciliation orchestrator 402 creates an example reconciliation parent task 704 that includes an example first reconciliation child task 706 and an example second reconciliation child task 708.

In the illustrated example of FIG. 7, the first reconciliation child task 706 is to be executed by the domain manager 112 to apply an example first configuration drift 710 to an example first cluster 712 and an example second cluster 714. Additionally, in the example of FIG. 7, the first reconciliation child task 706 is to be executed by the domain manager 112 to apply an example second configuration drift 716 to an example edge cluster 718. In the example of FIG. 7, based on applying the first configuration drift 710 to the first cluster 712 and the second cluster 714, the domain manager 112 generates a first reconciliation record 720.

In the illustrated example of FIG. 7, the second reconciliation child task 708 is to be executed by the operations manager 110 to apply an example third configuration drift 722 to an example first host 724 and an example second host 726. In the example of FIG. 7, the first host 724 and the second host 726 correspond to physical devices. In the example of FIG. 7, based on applying the third configuration drift 722 to the first host 724 and the second host 726, the operations manager 110 generates a second reconciliation record 728.

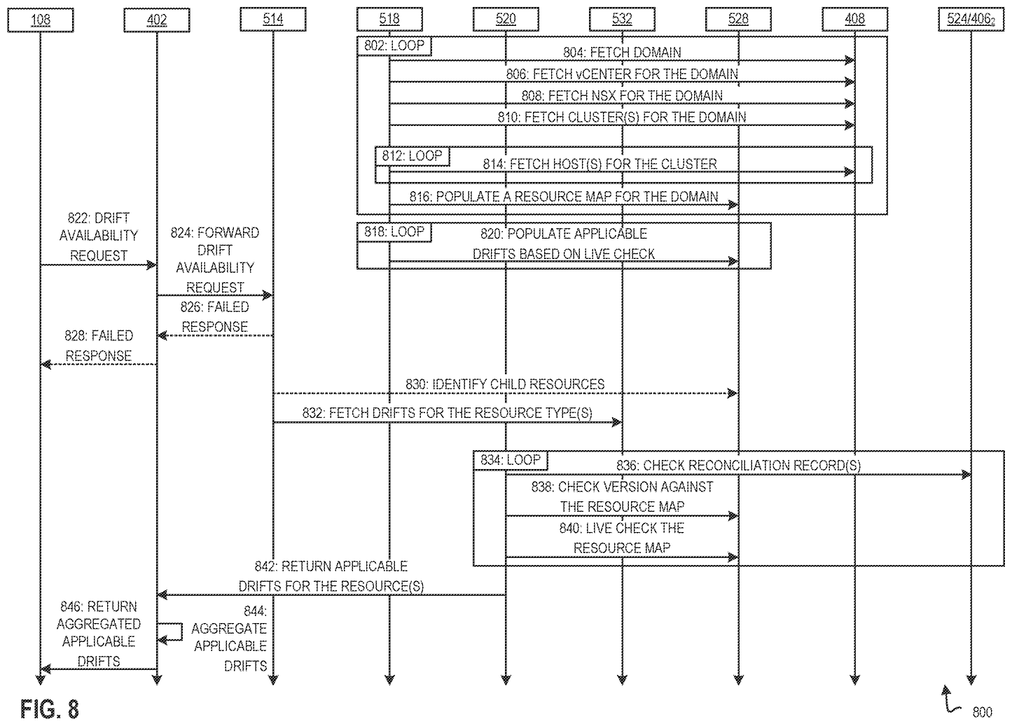

FIG. 8 is a sequence diagram 800 illustrating an example response to a drift availability request. In the example of FIG. 8, the sequence diagram 800 includes an example resource map populating loop 802 in which the resource mapping service 518 populates the resource map 528. For example, at operation 804, the resource mapping service 518 fetches a domain managed by the manager service associated with the configuration reconciler service 404. At operation 806, the resource mapping service 518 fetches a VMware vCenter® virtual infrastructure server for the domain. At operation 808, the resource mapping service 518 fetches a VMware NSX® network virtualization manager for the domain. In the example of FIG. 8, the resource mapping service 518 can repeat the resource map populating loop 802 periodically and/or asynchronously.

In the illustrated example of FIG. 8, at operation 810, the resource mapping service 518 fetches one or more clusters for the domain. In the example of FIG. 8, the sequence diagram 800 includes an example cluster populating loop 812 in which the resource mapping service 518 fetches one or more hosts for each cluster of the domain at operation 814. For example, at operation 814, the resource mapping service 518 fetches the one or more hosts. At operation 816, resource mapping service 518 populates the resource map 528 based on the data fetched.

In the illustrated example of FIG. 8, the sequence diagram 800 includes a resource map live checking loop 818 in which the resource mapping service 518 populates the resource map 528 based on a live check of the inventory 408 at operation 820. In the example of FIG. 8, the resource mapping service 518 executes the resource map live checking loop 818 after the configuration reconciler service 404 has started up. Additionally or alternatively, the resource mapping service 518 executes the resource map live checking loop 818 periodically. In some examples, the resource mapping service 518 executes the resource map live checking loop 818 asynchronously. For example, the resource mapping service 518 executes the resource map live checking loop 818 when a version change of a resource of the SDDC 100 is detected.

In the illustrated example of FIG. 8, at operation 822, the configuration drift reconciliation orchestrator 402 receives a drift availability request from the interface 108 (e.g., from a user via a UI implemented by the interface 108). In the example of FIG. 8, at operation 824, the configuration drift reconciliation orchestrator 402 forwards the drift availability request to the API controller 514.

In the illustrated example of FIG. 8, at operation 826, if the API controller 514 fails to handle the drift availability request, the API controller 514 sends a failed response to the configuration drift reconciliation orchestrator 402. For example, a failed response indicates that a particular manager service is unavailable or that an incorrect request was transmitted. At operation 828, the configuration drift reconciliation orchestrator 402 forwards the failed response to the interface 108. Alternatively, if the API controller 514 can handle the drift availability request, the API controller 514 determines if a resource identified in the drift availability request is an uber resource or a granular resource. If the resource is an uber resource, the API controller 514 identifies child resources of the uber resource at operation 830 by accessing the resource map 528.

In the illustrated example of FIG. 8, at operation 832, the API controller 514 fetches one or more configuration drifts for the identified resource type(s) by accessing the configuration drift metadata, recipes, and/or cookbooks 532 corresponding to the manager service associated with the configuration reconciler service 404. In the example of FIG. 8, the sequence diagram 800 includes an example drift applicability loop 834. In the example drift applicability loop 834, the applicability service 520 determines whether one or more configuration drifts returned by the drift detector service 516 are applicable to the associated resources of the inventory 408. For example, the applicability service 520 checks the one or more reconciliation records 530 stored in the database 406₂ at operation 836 via the configuration reconciler service DAL interface 524 to determine if a configuration drift has already been applied. In the example drift applicability loop 834, the applicability service 520 checks one or more versions identified in the configuration drift metadata, recipes, and/or cookbooks 532 corresponding to the manager service associated with the configuration reconciler service 404 at operation 838. For example, the applicability service 520 checks the one or more versions against the version(s) of corresponding resource(s) in the resource map 528. In the example drift applicability loop 834, the applicability service 520 performs a live check of the resource map 528 at operation 840.

In the illustrated example of FIG. 8, at operation 842, the applicability service 520 returns one or more applicable configuration drifts to the configuration drift reconciliation orchestrator 402. In the example of FIG. 8, the applicability service 520 also returns static drift metadata and dynamic applicability information to the configuration drift reconciliation orchestrator 402. At operation 844, the configuration drift reconciliation orchestrator 402 aggregates one or more applicable configuration drifts returned by manager services registered with the orchestration service 504. For example, for all manager services registered with the configuration drift reconciliation orchestrator 402, the configuration drift reconciliation orchestrator 402 aggregates the applicable configuration drifts. At operation 846, the configuration drift reconciliation orchestrator 402 returns the aggregated applicable configuration drifts to the interface 108.

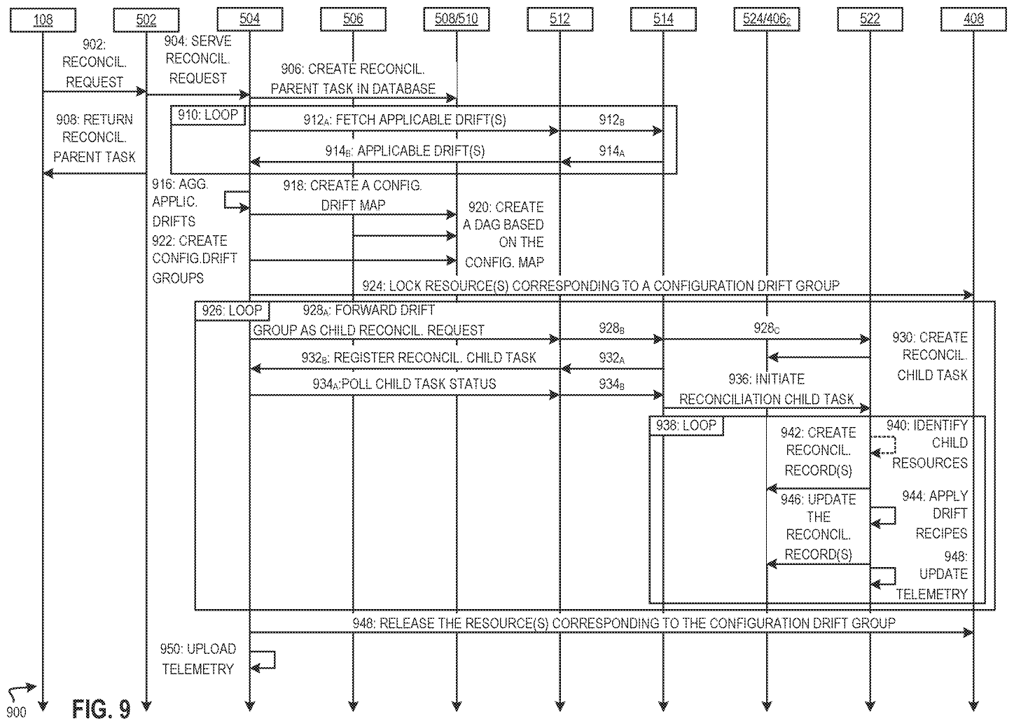

FIG. 9 is a sequence diagram 900 illustrating an example response to a reconciliation request. In the example of FIG. 9, the sequence diagram 900 begins at operation 902 where the API controller 502 receives a reconciliation request from the interface 108. At operation 904, the API controller 502 serves the reconciliation request to the orchestration service 504. At operation 906, the orchestration service 504 creates a reconciliation parent task for the reconciliation request in the orchestrator datastore 510 via the orchestrator DAL interface 508. At operation 908, the API controller 502 returns the reconciliation parent task to the interface 108.

In the illustrated example of FIG. 9, the sequence diagram 900 includes an example drift availability request loop 910 in which the orchestration service 504 fetches applicable configuration drifts from the configuration reconciler service 404. For example, at operation 912_{A}, the orchestration service 504 requests the API client 512 to send a drift availability request to the configuration reconciler service 404. At operation 912_{B}, the API client 512 sends the drift availability request to the API controller 514. In the drift availability request loop 910, the configuration reconciler service 404 returns one or more applicable configuration drifts to the orchestration service 504. For example, at operation 914_{A}, the API controller 514 returns one or more applicable configuration drifts to the API client 512. At operation 914_{B}, the API client 512 forwards the one or more applicable configuration drifts to the orchestration service 504. In the example of FIG. 9, the drift availability request loop 910 is repeated for each manager service registered with the orchestration service 504.

In the illustrated example of FIG. 9, at operation 916, the orchestration service 504 aggregates one or more applicable configuration drifts returned by the configuration reconciler service 404. At operation 918, the orchestration service 504 creates a configuration drift map in the orchestrator datastore 510 via the orchestrator DAL interface 508. At operation 920, the configuration sequence service 506 creates a DAG in the orchestrator datastore 510 (e.g., via the orchestrator DAL interface 508) based on the configuration map. At operation 922, the orchestration service 504 creates one or more configuration drift groups in the orchestrator datastore 510 (e.g., via the orchestrator DAL interface 508) per manager service registered with the orchestration service 504. At operation 924, the orchestration service 504 locks one or more resources in the inventory 408 corresponding to a configuration drift group.

In the illustrated example of FIG. 9, the sequence diagram 900 includes an example reconciliation child task generating loop 926 in which the orchestration service 504 forwards a child reconciliation request to the configuration reconciler service 404. For example, at operation 928_{A}, the orchestration service 504 requests the API client 512 to forward a configuration drift group to the configuration reconciler service 404 as a child reconciliation request. At operation 928_{B}, the API client 512 forwards the child reconciliation request to the API controller 514. At operation 928_{C}, the API controller 514 forwards the child reconciliation request to the reconciliation FSM service 522. At operation 930, the reconciliation FSM service 522 creates a reconciliation child task corresponding to the child reconciliation request in the database 406₂ via the configuration reconciler service DAL interface 524. At operation 932_{A}, the API controller 514 requests the API client 512 to register the reconciliation child task with the orchestration service 504. At operation 932_{B}, t the API client 512 registers the reconciliation child task with the orchestration service 504. In the example of FIG. 9, a child reconciliation request includes an identifier of a resource to be reconciled according to the reconciliation request and one or more identifiers of configuration drifts (e.g., updated configurations) with which the resource is to be reconciled.

In the illustrated example of FIG. 9, at operation 934_{A}, the orchestration service 504 requests the API client 512 to poll the reconciliation child task status. At operation 934_{B}, the API client 512 polls the API controller 514 for the reconciliation child task status. For example, because reconciliation child tasks may be completed asynchronously, polling the child task status allows the orchestration service 504 to determine when to conclude the reconciliation child task generating loop 926. At operation 936, the API controller 514 initiates a reconciliation child task for the reconciliation FSM service 522. In the example of FIG. 9, the sequence diagram 900 includes an example configuration reconciling loop 938. In the example of FIG. 9, the reconciliation FSM service 522 executes the configuration reconciling loop 938 for each configuration drift in a configuration drift group. In the configuration reconciling loop 938, if a configuration drift of the reconciliation child task is associated with an uber resource, the reconciliation FSM service 522 identifies child resources of the uber resource at operation 940 where the configuration drift is applicable.

In the example configuration reconciling loop 938, at operation 942, the reconciliation FSM service 522 creates one or more reconciliation records in the database 406₂ for the configuration drift (e.g., via the configuration reconciler service DAL interface 524). As described above, a reconciliation record is identifiable via a data tuple including a task ID, a configuration drift ID, and a resource ID. In the example configuration reconciling loop 938, at operation 944, the reconciliation FSM service 522 applies one or more drift recipes stored in the configuration datastore 406 to the identified resources to reconcile the configuration drift. At operation 946 of the example configuration reconciling loop 938, the reconciliation FSM service 522 updates the one or more reconciliation records stored in the database 406₂ via the configuration reconciler service DAL interface 524. At operation 948, the reconciliation FSM service 522 updates telemetry data to a management server upon completion of the reconciliation child task. Example telemetry data includes a configuration drift ID, a configuration drift name, a status of reconciliation, a reconciliation child task ID, any errors that occurred during reconciliation, resource IDs of resources where reconciliation was successful, is pending, and/or failed, a start time of the reconciliation child task, and an end time of the reconciliation child task. In the example of FIG. 9, the orchestration service 504 repeats the reconciliation child task generating loop 926 for each configuration drift group of the DAG. At operation 950, the orchestration service 504 releases the one or more resources corresponding to the configuration drift group. At operation 952, the orchestration service 504 uploads telemetry data to the management server upon completion of the reconciliation parent task.

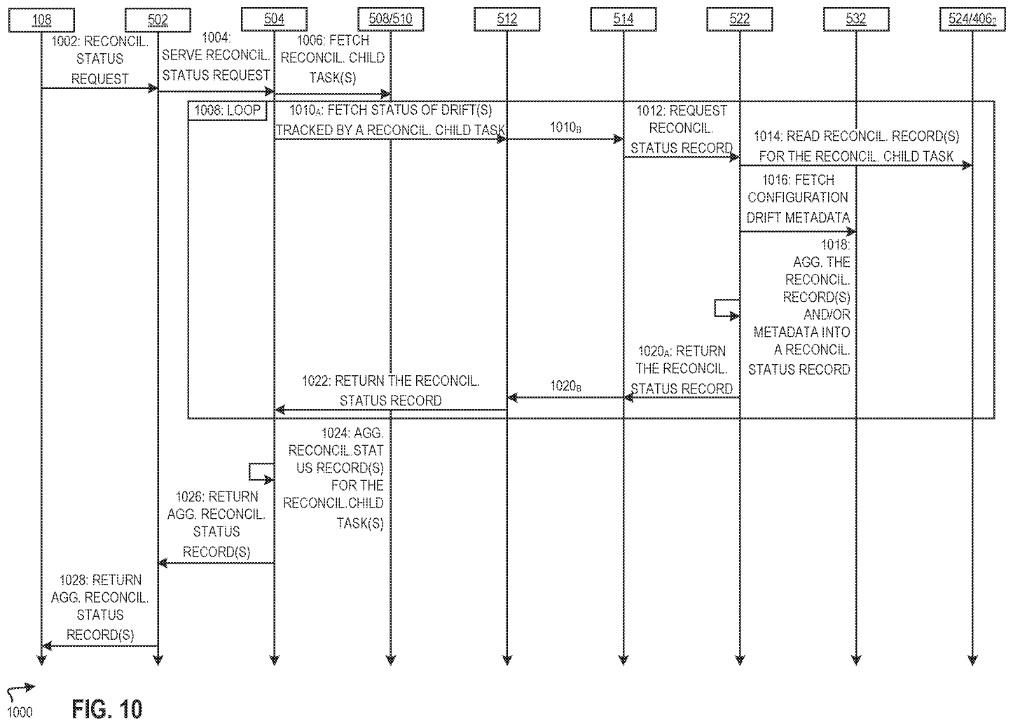

FIG. 10 is a sequence diagram 1000 illustrating an example response to a reconciliation status request. In the example of FIG. 10, the sequence diagram 1000 begins at operation 1002 where the API controller 502 receives a reconciliation status request from the interface 108. At operation 1004, the API controller 502 serves the reconciliation status request to the orchestration service 504. At operation 1006, the orchestration service 504 fetches one or more reconciliation child tasks from the orchestrator datastore 510 (e.g., via the orchestrator DAL interface 508) based on a task ID included with the reconciliation status request.

In the illustrated example of FIG. 10, the sequence diagram 1000 includes a reconciliation child task status checking loop 1008 which may be executed for each reconciliation child task associated with the task ID. At operation 1010_{A}, the orchestration service 504 requests that the API client 512 fetch the status of one or more configuration drifts tracked by a reconciliation child task. At operation 1010_{B}, the API client 512 transmits a reconciliation status request corresponding to the one or more configuration drifts to the API controller 514. At operation 1012, the API controller 514 requests a reconciliation status record for the reconciliation child task. At operation 1014, the reconciliation FSM service 522 reads the one or more reconciliation records 530 from the database 406₂ via the configuration reconciler service DAL interface 524. In the example of FIG. 10, the one or more reconciliation records 530 correspond to the reconciliation child task. At operation 1016, the reconciliation FSM service 522 fetches the configuration drift metadata, recipes, and/or cookbooks 532 corresponding to the reconciliation child task.

In the illustrated example of FIG. 10, at operation 1018, the reconciliation FSM service 522 aggregates the one or more reconciliation records 530 and/or the configuration drift metadata, recipes, and/or cookbooks 532 corresponding to the reconciliation child task into a reconciliation status record. An example reconciliation status record includes identifiers of respective configuration drifts to be reconciled according to a reconciliation task identified in a reconciliation status request, respective statuses of the respective configuration drifts reconciliation processes, and/or any errors that occurred during the respective configuration drifts reconciliation processes. At operation 1020_{A}, the reconciliation FSM service 522 returns the reconciliation status record to the API controller 514. At operation 1020_{B}, the API controller 514 returns the reconciliation status record to the API client 512. At operation 1022, the API client 512 returns to the reconciliation status record to the orchestration service 504.

In the illustrated example of FIG. 10, at operation 1024, the orchestration service 504 aggregates one or more reconciliation status records for the one or more reconciliation child tasks associated with the task ID included with the reconciliation status request. At operation 1026, the orchestration service 504 returns the one or more aggregated reconciliation status records to the API controller 502. At operation 1028, the API controller 502 returns the one or more aggregated reconciliation status records to the interface 108.

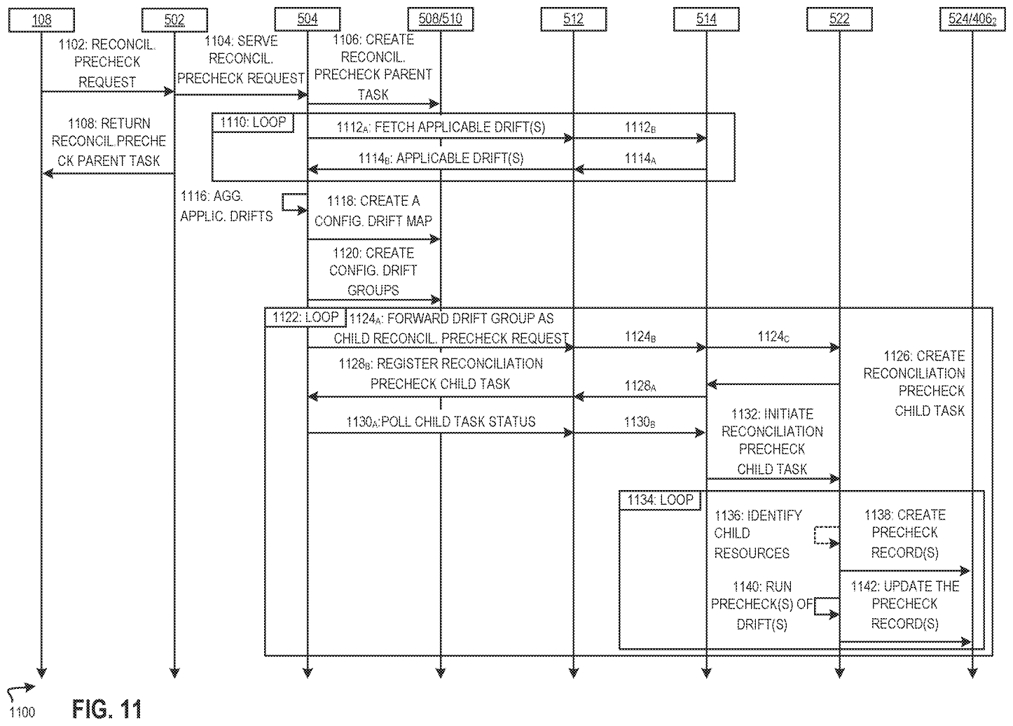

FIG. 11 is a sequence diagram 1100 illustrating an example response to a reconciliation precheck request. In examples disclosed herein, when a configuration drift reconciliation attempt fails on one or more resources, an SDDC could be placed in an inconsistent state, which may require manual intervention to remedy. By prechecking the reconciliation of configuration drifts, examples disclosed herein facilitate dry-running reconciliation of configuration drifts on granular resources. By executing prechecks, examples disclosed herein preemptively identify any issues that could cause reconciliation of a configuration drift application to fail. As described below, examples disclosed herein execute prechecks individually for one or more applicable configuration drifts, for each granular resource to which the one or more configuration drifts will be applied during reconciliation.

In the illustrated example of FIG. 11, the sequence diagram 1100 begins at operation 1102 where the API controller 502 receives a reconciliation precheck request from the interface 108. At operation 1104, the API controller 502 serves the reconciliation precheck request to the orchestration service 504. At operation 1106, the orchestration service 504 creates a reconciliation precheck parent task for the reconciliation precheck request in the orchestrator datastore 510 via the orchestrator DAL interface 508. At operation 1108, the API controller 502 returns the reconciliation precheck parent task to the interface 108.

In the illustrated example of FIG. 11, the sequence diagram 1100 includes an example drift availability request loop 1110 in which the orchestration service 504 fetches applicable configuration drifts from the configuration reconciler service 404. For example, at operation 1112_{A}, the orchestration service 504 requests the API client 512 to send a drift availability request to the configuration reconciler service 404. At operation 1112_{B}, the API client 512 sends the drift availability request to the API controller 514. In the drift availability request loop 1110, the configuration reconciler service 404 returns one or more applicable configuration drifts to the orchestration service 504. For example, at operation 1114_{A}, the API controller 514 returns one or more applicable configuration drifts to the API client 512. At operation 1114_{B}, the API client 512 forwards the one or more applicable configuration drifts to the orchestration service 504. In the example of FIG. 11, the drift availability request loop 1110 is repeated for each manager service registered with the orchestration service 504.

In the illustrated example of FIG. 11, at operation 1116, the orchestration service 504 aggregates one or more applicable configuration drifts returned by the configuration reconciler service 404. At operation 1118, the orchestration service 504 creates a configuration drift map in the orchestrator datastore 510 (e.g., via the orchestrator DAL interface 508). At operation 1120, the orchestration service 504 creates one or more configuration drift groups in the orchestrator datastore 510 (e.g., via the orchestrator DAL interface 508) per manager service registered with the orchestration service 504. In the example of FIG. 11, the sequence diagram 1100 includes an example reconciliation precheck child task generating loop 1122 in which the orchestration service 504 forwards a child reconciliation precheck request to the configuration reconciler service 404. For example, at operation 1124_{A}, the orchestration service 504 requests the API client 512 to forward a configuration drift group to be prechecked to the configuration reconciler service 404 as a child reconciliation precheck request. At operation 1124_{B}, the API client 512 forwards the child reconciliation precheck request to the API controller 514. At operation 1124_{C}, the API controller 514 forwards the child reconciliation precheck request to the reconciliation FSM service 522. At operation 1126, the reconciliation FSM service 522 creates a reconciliation precheck child task corresponding to the child reconciliation precheck request in the database 406₂ via the configuration reconciler service DAL interface 524. At operation 1128_{A}, the API controller 514 requests the API client 512 to register the reconciliation precheck child task with the orchestration service 504. At operation 1128_{B}, the API client 512 registers the reconciliation precheck child task with the orchestration service 504.

In the illustrated example of FIG. 11, at operation 1130_{A}, the orchestration service 504 requests the API client 512 to poll the reconciliation precheck child task status. At operation 1130_{B}, the API client 512 polls the API controller 514 for the reconciliation precheck child task status. For example, because reconciliation precheck child tasks may be completed asynchronously, polling the child task status allows the orchestration service 504 to determine when to conclude the reconciliation precheck child task generating loop 1122. At operation 1132, the API controller 514 initiates a reconciliation precheck child task for the reconciliation FSM service 522. In the example of FIG. 11, the sequence diagram 1100 includes an example configuration reconciling precheck loop 1134. In the example of FIG. 11, the reconciliation FSM service 522 executes the configuration reconciling precheck loop 1134 for each configuration drift in a configuration drift group. In the configuration reconciling precheck loop 1134, if a configuration drift of the reconciliation precheck child task is associated with an uber resource, the reconciliation FSM service 522 identifies child resources of the uber resource at operation 1136 where the configuration drift is applicable.

In the example configuration reconciling precheck loop 1134, at operation 1138, the reconciliation FSM service 522 creates one or more precheck records in the database 406₂ for the configuration drift (e.g., via the configuration reconciler service DAL interface 524). In the example of FIG. 11, a precheck record is identifiable via a data tuple including a task ID, a configuration drift ID, and a resource ID. In the example configuration reconciling precheck loop 1134, at operation 1140, the reconciliation FSM service 522 runs one or more prechecks on the one or more configuration drifts. For example, the reconciliation FSM service 522 applies one or more drift recipes stored in the configuration datastore 406 to the identified resources in a sandbox environment. At operation 1142 of the example configuration reconciling precheck loop 1134, the reconciliation FSM service 522 updates the one or more precheck records stored in database 406₂ via the configuration reconciler service DAL interface 524. In the example of FIG. 11, the orchestration service 504 repeats the reconciliation precheck child task generating loop 1122 for each configuration drift group.

Subsequently, the one or more reconciliation records generated during the configuration reconciling precheck loop 1134 may be retrieved and presented via the interface 108. In some examples, a user can check whether a configuration has been realized and/or whether a configuration is ready for application. For example, to check whether a configuration has been realized, a user can initiate a drift availability request. Additionally, for example, to check whether a configuration is ready for application, a user can initiate a reconciliation precheck request. The reconciliation records returned based on a reconciliation precheck request indicate if a configuration drift can or cannot be applied successfully. For example, the reconciliation FSM service 522 implements a dry run (e.g., precheck) of a configuration drift either in response to a reconciliation precheck request and/or as part of responding to a reconciliation request. If any exception is thrown during the drift dry run completed as part of responding to a reconciliation request, the reconciliation record is marked as failed and a candidate cause of the error, description, and suggested remedy is returned as part of the precheck result. If an exception is through the drift dry run completed as part of a reconciliation precheck request, the reconciliation record may not be updated.

While an example manner of implementing the configuration drift reconciliation orchestrator 402 of FIG. 4 is illustrated in FIG. 5, one or more of the elements, processes, and/or devices illustrated in FIG. 5 may be combined, divided, re-arranged, omitted, eliminated, and/or implemented in any other way. Additionally, while an example manner of implementing the configuration reconciler service 404 of FIG. 4 is illustrated in FIG. 5, one or more of the elements, processes, and/or devices illustrated in FIG. 5 may be combined, divided, re-arranged, omitted, eliminated, and/or implemented in any other way. Further, the example API controller 502, the example orchestration service 504, the example configuration sequence service 506, the example orchestrator DAL interface 508, the example orchestrator datastore 510, the example API client 512, and/or, more generally, the example configuration drift reconciliation orchestrator 402 of FIG. 5 and/or the example API controller 514, the example drift detector service 516, the example resource mapping service 518, the example applicability service 520, the example reconciliation FSM service 522, the example configuration reconciler service DAL interface 524, and/or, more generally, the example configuration reconciler service 404 of FIG. 5, may be implemented by hardware alone or by hardware in combination with software and/or firmware. Thus, for example, any of the example API controller 502, the example orchestration service 504, the example configuration sequence service 506, the example orchestrator DAL interface 508, the example orchestrator datastore 510, the example API client 512, and/or, more generally, the example configuration drift reconciliation orchestrator 402 of FIG. 5 and/or the example API controller 514, the example drift detector service 516, the example resource mapping service 518, the example applicability service 520, the example reconciliation FSM service 522, the example configuration reconciler service DAL interface 524, and/or, more generally, the example configuration reconciler service 404 of FIG. 5, could be implemented by programmable circuitry in combination with machine-readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example configuration drift reconciliation orchestrator 402 of FIG. 5 may include one or more elements, processes, and/or devices in addition to, or instead of, those illustrated in FIG. 5, and/or may include more than one of any or all of the illustrated elements, processes, and devices. Additionally, the example configuration reconciler service 404 of FIG. 5 may include one or more elements, processes, and/or devices in addition to, or instead of, those illustrated in FIG. 5, and/or may include more than one of any or all of the illustrated elements, processes, and devices.

Flowchart(s) representative of example machine-readable instructions, which may be executed by programmable circuitry to implement and/or instantiate the configuration drift reconciliation orchestrator 402 of FIG. 5 and/or representative of example operations which may be performed by programmable circuitry to implement and/or instantiate the configuration drift reconciliation orchestrator 402 of FIG. 5, are shown in FIGS. 12, 15, 17, and 19. Additionally, flowchart(s) representative of example machine-readable instructions, which may be executed by programmable circuitry to implement and/or instantiate the configuration reconciler service 404 of FIG. 5 and/or representative of example operations which may be performed by programmable circuitry to implement and/or instantiate the configuration reconciler service 404 of FIG. 5, are shown in FIGS. 13, 14, 16, 18, and 20. The machine-readable instructions may be one or more executable programs or portion(s) of one or more executable programs for execution by programmable circuitry such as the programmable circuitry 2112 shown in the example programmable circuitry platform 2100 discussed below in connection with FIG. 21 and/or may be one or more function(s) or portion(s) of functions to be performed by the example programmable circuitry (e.g., an FPGA) discussed below in connection with FIGS. 22 and/or 23. In some examples, the machine-readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer-readable and/or machine-readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer-readable and/or machine-readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer-readable storage medium may include one or more mediums. Further, although the example program is described with reference to the flowchart(s) illustrated in FIGS. 12, 13, 14, 15, 16, 17, 18, 19, and 20, many other methods of implementing the example configuration drift reconciliation orchestrator 402 and/or the example configuration reconciler service 404 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine-readable instructions described herein may be stored in one or more of a compressed format, an encrypted format, a fragmented format, a compiled format, an executable format, a packaged format, etc. Machine-readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine-executable instructions. For example, the machine-readable instructions may be fragmented and stored on one or more storage devices, disks and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of computer-executable and/or machine-executable instructions that implement one or more functions and/or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine-readable, computer-readable and/or machine-readable media, as used herein, may include instructions and/or program(s) regardless of the particular format or state of the machine-readable instructions and/or program(s).

The machine-readable instructions described herein can be represented by any past, present, or future instruction language, scripting language, programming language, etc. For example, the machine-readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 12, 13, 14, 15, 16, 17, 18, 19, and 20 may be implemented using executable instructions (e.g., computer-readable and/or machine-readable instructions) stored on one or more non-transitory computer-readable and/or machine-readable media. As used herein, the terms non-transitory computer-readable medium, non-transitory computer-readable storage medium, non-transitory machine-readable medium, and/or non-transitory machine-readable storage medium are expressly defined to include any type of computer-readable storage device and/or storage disk and to exclude propagating signals and to exclude transmission media. Examples of such non-transitory computer-readable medium, non-transitory computer-readable storage medium, non-transitory machine-readable medium, and/or non-transitory machine-readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer-readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer-readable storage devices and/or non-transitory machine-readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer-readable instructions, machine-readable instructions, etc., and/or manufactured to execute computer-readable instructions, machine-readable instructions, etc.

FIG. 12 is a flowchart representative of example machine-readable instructions and/or example operations 1200 that may be executed, instantiated, and/or performed by example programmable circuitry to implement the configuration drift reconciliation orchestrator 402 of FIG. 5 to respond to a drift availability request. The example machine-readable instructions and/or the example operations 1200 of FIG. 12 begin at block 1202, at which the API controller 502 monitors an API (e.g., the interface 108). At block 1204, the API controller 502 determines whether a drift availability request has been received from an API client.

In the illustrated example of FIG. 12, at block 1206, the orchestration service 504 identifies a resource associated with the drift availability request based on an identifier included with the drift availability request. At block 1208, the API client 512 forwards the drift availability request to a configuration reconciler service of a manager service that manages the resource. In the example of FIG. 12, the API client 512 accesses an applicable configuration drift from the configuration reconciler service at block 1210. At block 1212, the orchestration service 504 determines if there is an additional manager service that manages the resource.

In the illustrated example of FIG. 12, based on (e.g., in response to) the orchestration service 504 determining that there is an additional manager service that manages the resource (block 1212: YES), the machine-readable instructions and/or the operations 1200 return to block 1208. Based on (e.g., in response to) the orchestration service 504 determining that there is not an additional manager service that manages the resource (block 1212: NO), the machine-readable instructions and/or the operations 1200 proceed to block 1214. At block 1214, the orchestration service 504 aggregates one or more applicable configuration drifts returned from the one or more configuration reconciler services of the one or more manager services that manage the resource. At block 1216, the API controller 502 returns the aggregated applicable configuration drifts to the API client.

FIG. 13 is a flowchart representative of example machine-readable instructions and/or example operations 1300 that may be executed, instantiated, and/or performed by example programmable circuitry to implement the configuration reconciler service 404 of FIG. 5 to respond to a drift availability request. The example machine-readable instructions and/or the example operations 1300 of FIG. 13 begin at block 1302, at which the resource mapping service 518 populates a resource map for a domain managed by a manager service. At block 1304, the resource mapping service 518 updates the resource map. For example, the resource mapping service 518 can update the resource map periodically, asynchronously, and/or otherwise.

In the illustrated example of FIG. 13, at block 1306, the API controller 514 determines whether a drift availability request has been received. Based on (e.g., in response to) the API controller 514 determining that a drift availability request has not been received (block 1306: NO), the machine-readable instructions and/or the operations 1300 return to block 1304. Based on (e.g., in response to) the API controller 514 determining that a drift availability request has been received (block 1306: YES), the machine-readable instructions and/or the operations 1300 proceed to block 1308.

In the illustrated example of FIG. 13, at block 1308, the drift detector service 516 identifies a resource associated with the drift availability request based on an identifier included with the drift availability request. At block 1310, the drift detector service 516 determines if the resource is a granular resource. Based on (e.g., in response to) the drift detector service 516 determining that the resource is not a granular resource (block 1310: NO), the machine-readable instructions and/or the operations 1300 proceed to block 1312. At block 1312, the drift detector service 516 identifies granular resources of the resource (e.g., uber resource) based on the resource map populated at block 1302 and/or updated at block 1304. Based on (e.g., in response to) the drift detector service 516 determining that the resource is a granular resource (block 1310: YES), the machine-readable instructions and/or the operations 1300 proceed to block 1314.

In the illustrated example of FIG. 13, at block 1314, the drift detector service 516 determines one or more configuration drifts corresponding to the one or more identified resources. For example, the drift detector service 516 accesses configuration drift metadata populated in the configuration datastore 406 populated as part of an update to a configuration of an identified resource. At block 1316, the applicability service 520 determines if the one or more configuration drifts are applicable to the one or more identified resources. Example machine-readable instructions and/or example operations to implement block 1316 are described in connection with FIG. 14. At block 1318, the API controller 514 returns at least one applicable configuration drift.

FIG. 14 is a flowchart representative of example machine-readable instructions and/or example operations 1400 that may be executed, instantiated, and/or performed by example programmable circuitry to implement the configuration reconciler service 404 of FIG. 5 to determine if a configuration drift is applicable to a resource. The example machine-readable instructions and/or the example operations 1400 of FIG. 14 begin at block 1402, at which the applicability service 520 checks one or more reconciliation records to determine if a configuration drift has been reconciled with a resource. For example, the applicability service 520 determines the status of a reconciliation child task in a reconciliation record. If the status of the reconciliation child task indicates that the reconciliation child task has failed, the applicability service 520 determines that the configuration drift has not been reconciled with the resource and is therefore applicable to the resource.

In the illustrated example of FIG. 14, at block 1404, the applicability service 520 checks a version in drift metadata to determine if the configuration drift has been reconciled. For example, the applicability service 520 determines if a version of a product implemented utilizing the resource satisfies a version of the product identified in an applicability field of configuration drift metadata for the configuration drift. If a version of a product implemented utilizing the resource does not satisfy a version of the product identified in an applicability field of configuration drift metadata, the applicability service 520 determines that the configuration drift has not been reconciled with the resource and is therefore applicable to the resource.

In the illustrated example of FIG. 14, at block 1406, the applicability service 520 checks the resource in the resource map to determine if the configuration drift has been reconciled. For example, the applicability service 520 determines if a data field of a node of the resource map corresponding to the resource indicates that a configuration drift reconciliation is pending (e.g., a configuration drift has yet to be reconciled with the resource). If the data field of the node corresponding to the resource indicates that the configuration drift reconciliation is pending, the applicability service 520 determines that the configuration drift has not been reconciled with the resource and is therefore applicable to the resource.

In the illustrated example of FIG. 14, at block 1408, the applicability service 520 determines if the configuration drift has been reconciled. Based on (e.g., in response to) the applicability service 520 determining that the configuration drift has not been reconciled (block 1408: NO), the machine-readable instructions and/or the operations 1400 proceed to block 1410. Based on (e.g., in response to) the applicability service 520 determining that the configuration drift has been reconciled (block 1408: YES), the machine-readable instructions and/or the operations 1400 proceed to block 1412.

In the illustrated example of FIG. 14, at block 1410, the applicability service 520 classifies the configuration drift as applicable to the resource. At block 1412, the applicability service 520 classifies the configuration drift as non-applicable to the resource. At block 1414, the applicability service 520 determines if there is an additional configuration drift for the resource. Based on (e.g., in response to) the applicability service 520 determining that there is an additional configuration drift (block 1414: YES), the machine-readable instructions and/or the operations 1400 return to block 1402. Based on (e.g., in response to) the applicability service 520 determining that there is not an additional configuration drift (block 1414: NO), the machine-readable instructions and/or the operations 1400 return the machine-readable instructions and/or the operations 1300 at block 1318.

FIG. 15 is a flowchart representative of example machine-readable instructions and/or example operations 1500 that may be executed, instantiated, and/or performed by example programmable circuitry to implement the configuration drift reconciliation orchestrator 402 of FIG. 5 to respond to a reconciliation request. The example machine-readable instructions and/or the example operations 1500 of FIG. 15 begin at block 1502, at which the API controller 502 monitors an API (e.g., the interface 108). At block 1504, the API controller 502 determines if a reconciliation request has been received from an API client.

In the illustrated example of FIG. 15, based on (e.g., in response to) the API controller 502 determining that a reconciliation request has not been received (block 1504: NO), the machine-readable instructions and/or the operations 1500 return to block 1502. Based on (e.g., in response to) the API controller 502 determining that a reconciliation request has been received (block 1504: YES), the machine-readable instructions and/or the operations 1500 proceed to block 1506. At block 1506, the orchestration service 504 creates a reconciliation parent task for the reconciliation request in the orchestrator datastore 510. At block 1508, the orchestration service 504 identifies a resource associated with the reconciliation request based on an identifier included with the reconciliation request.

In the illustrated example of FIG. 15, at block 1510, the API client 512 sends a drift availability request to a configuration reconciler service of a manager service that manages the resource. At block 1512, the API client 512 accesses an applicable configuration drift from the configuration reconciler service. At block 1514, the orchestration service 504 determines if an additional manager service manages the resource. In the illustrated example of FIG. 15, based on (e.g., in response to) the orchestration service 504 determining that there is an additional manager service that manages the resource (block 1514: YES), the machine-readable instructions and/or the operations 1500 return to block 1510. Based on (e.g., in response to) the orchestration service 504 determining that there is not an additional manager service that manages the resource (block 1514: NO), the machine-readable instructions and/or the operations 1500 proceed to block 1516.

In the illustrated example of FIG. 15, at block 1516, the orchestration service 504 aggregates one or more applicable configuration drifts returned from the one or more configuration reconciler services. At block 1518, the orchestration service 504 creates a configuration drift map in the orchestrator datastore 510. The example configuration drift map associates the one or more applicable configuration drifts with respective manager services. At block 1520, the configuration sequence service 506 creates a DAG in the orchestrator datastore 510 based on the configuration drift map. In the example of FIG. 15, the DAG defines a sequence according to which the one or more applicable configuration drifts is/are to be reconciled with the resource. In the example of FIG. 15, at block 1522, the orchestration service 504 creates a group of the one or more applicable configuration drifts from the DAG per manager service. At block 1524, the API client 512 forwards a child reconciliation request to the one or more configuration reconciler services to apply the group to the resource per manager service.

FIG. 16 is a flowchart representative of example machine-readable instructions and/or example operations 1600 that may be executed, instantiated, and/or performed by example programmable circuitry to implement the configuration reconciler service 404 of FIG. 5 to respond to a reconciliation request. The example machine-readable instructions and/or the example operations 1600 of FIG. 16 begin at block 1602, at which the API controller 514 monitors an API. At block 1604, the API controller 514 determines if a child reconciliation request has been received. Based on (e.g., in response to), the API controller 514 determining that a child reconciliation request has not been received (block 1604: NO), the machine-readable instructions and/or the operations 1600 return to block 1602.

In the illustrated example of FIG. 16, based on (e.g., in response to), the API controller 514 determining that a child reconciliation request has been received (block 1604: YES), the machine-readable instructions and/or the operations 1600 proceed to block 1606. Additionally, based on (e.g., in response to), the API controller 514 determining that a child reconciliation request has been received (block 1604: YES), the API controller 514 creates a reconciliation child task. At block 1606, the reconciliation FSM service 522 identifies a resource associated with the child reconciliation request based on an identifier included with the child reconciliation request. At block 1608, the reconciliation FSM service 522 determines if the resource is a granular resource. Based on (e.g., in response to) the reconciliation FSM service 522 determining that the resource is not a granular resource (block 1608: NO), the machine-readable instructions and/or the operations 1600 proceed to block 1610. At block 1610, the reconciliation FSM service 522 identifies granular resources of the resource (e.g., uber resource) based on a resource map for a domain of the resource. Based on (e.g., in response to) the reconciliation FSM service 522 determining that the resource is a granular resource (block 1608: YES), the machine-readable instructions and/or the operations 1600 proceed to block 1612.

In the illustrated example of FIG. 16, at block 1612, the reconciliation FSM service 522 creates a reconciliation record in the configuration datastore 406 for a configuration drift identified in the child reconciliation request. As described above, the reconciliation record is identifiable by a task ID of the reconciliation child task. At block 1614, the reconciliation FSM service 522 initiates an FSM to reconcile the configuration drift with the one or more identified resources. At block 1616, the reconciliation FSM service 522 updates the reconciliation record based on a status of the FSM.

In the illustrated example of FIG. 16, at block 1618, the reconciliation FSM service 522 determines if there is an additional configuration drift identified in the child reconciliation request. Based on (e.g., in response to), the reconciliation FSM service 522 determining that there is an additional configuration drift identified in the child reconciliation request (block 1618: YES), the machine-readable instructions and/or the operations 1600 return to block 1606. Based on (e.g., in response to), the reconciliation FSM service 522 determining that there is not an additional configuration drift identified in the child reconciliation request (block 1618: NO), the machine-readable instructions and/or the operations 1600 terminate.

FIG. 17 is a flowchart representative of example machine-readable instructions and/or example operations 1700 that may be executed, instantiated, and/or performed by example programmable circuitry to implement the configuration drift reconciliation orchestrator 402 of FIG. 5 to respond to a reconciliation status request. The example machine-readable instructions and/or the example operations 1700 of FIG. 17 begin at block 1702, at which the API controller 502 monitors an API (e.g., the interface 108). At block 1704, the API controller 502 determines if a reconciliation status request has been received from an API client.

In the illustrated example of FIG. 17, based on (e.g., in response to) the API controller 502 determining that a reconciliation status request has not been received (block 1704: NO), the machine-readable instructions and/or the operations 1700 return to block 1702. Based on (e.g., in response to) the API controller 502 determining that a reconciliation status request has been received (block 1704: YES), the machine-readable instructions and/or the operations 1700 proceed to block 1706. At block 1706, the orchestration service 504 determines a reconciliation child task of a parent task identified in the reconciliation status request.

In the illustrated example of FIG. 17, at block 1708, the API client 512 requests a reconciliation status record for the reconciliation child task from a configuration reconciler service. At block 1710, the API client 512 accesses the reconciliation status record from the configuration reconciler service. In the example of FIG. 17, at block 1712, the orchestration service 504 determines if there is an additional reconciliation child task of the reconciliation parent task. Based on (e.g., in response to) the orchestration service 504 determining that there is an additional reconciliation child task of the reconciliation parent task (block 1712: YES), the machine-readable instructions and/or the operations 1700 return to block 1708.

In the illustrated example of FIG. 17, based on (e.g., in response to) the orchestration service 504 determining that there is not an additional reconciliation child task of the reconciliation parent task (block 1712: NO), the machine-readable instructions and/or the operations 1700 proceed to block 1714. At block 1714, the orchestration service 504 aggregates the reconciliation status records for respective reconciliation child tasks. At block 1716, the API controller 502 returns the aggregate reconciliation status records to the API client.

FIG. 18 is a flowchart representative of example machine-readable instructions and/or example operations 1800 that may be executed, instantiated, and/or performed by example programmable circuitry to implement the configuration reconciler service 404 of FIG. 5 to respond to a reconciliation status request. The example machine-readable instructions and/or the example operations 1800 of FIG. 18 begin at block 1802, at which the API controller 514 monitors an API. At block 1804, the API controller 514 determines if a reconciliation status request has been received from an API client. Based on (e.g., in response to), the API controller 514 determining that a reconciliation status request has not been received (block 1804: NO), the machine-readable instructions and/or the operations 1800 return to block 1802.

In the illustrated example of FIG. 18, based on (e.g., in response to), the API controller 514 determining that a reconciliation status request has been received (block 1804: YES), the machine-readable instructions and/or the operations 1800 proceed to block 1806. At block 1806, the reconciliation FSM service 522 determines a reconciliation child task identified in the reconciliation status request. At block 1808, the reconciliation FSM service 522 accesses a reconciliation record for a configuration drift associated with the reconciliation child task. At block 1810, the reconciliation FSM service 522 accesses configuration drift metadata for the configuration drift.

In the illustrated example of FIG. 18, at block 1812, the reconciliation FSM service 522 determines if there is an additional reconciliation record for the reconciliation child task. Based on (e.g., in response to) the reconciliation FSM service 522 determining that there is an additional reconciliation record for the reconciliation child task (block 1812: YES), the machine-readable instructions and/or the operations 1800 return to block 1808. Based on (e.g., in response to) the reconciliation FSM service 522 determining that there is not an additional reconciliation record for the reconciliation child task (block 1812: NO), the machine-readable instructions and/or the operations 1800 proceed to block 1814. In the example of FIG. 18, at block 1814, the reconciliation FSM service 522 aggregates the reconciliation records and/or configuration drift metadata for the configuration drifts into a reconciliation status record. At block 1816, the API controller 514 returns the reconciliation status record to the API client.

FIG. 19 is a flowchart representative of example machine-readable instructions and/or example operations 1900 that may be executed, instantiated, and/or performed by example programmable circuitry to implement the configuration drift reconciliation orchestrator 402 of FIG. 5 to respond to a reconciliation precheck request. The example machine-readable instructions and/or the example operations 1900 of FIG. 19 begin at block 1902, at which the API controller 502 monitors an API (e.g., the interface 108). At block 1904, the API controller 502 determines if a reconciliation precheck request has been received from an API client.

In the illustrated example of FIG. 19, based on (e.g., in response to) the API controller 502 determining that a reconciliation precheck request has not been received (block 1904: NO), the machine-readable instructions and/or the operations 1900 return to block 1902. Based on (e.g., in response to) the API controller 502 determining that a reconciliation precheck request has been received (block 1904: YES), the machine-readable instructions and/or the operations 1900 proceed to block 1906. At block 1906, the orchestration service 504 creates a reconciliation precheck parent task for the reconciliation precheck request in the orchestrator datastore 510. At block 1908, the orchestration service 504 identifies a resource associated with the reconciliation precheck request based on an identifier included with the reconciliation precheck request.

In the illustrated example of FIG. 19, at block 1910, the API client 512 sends a drift availability request to a configuration reconciler service of a manager service that manages the resource. At block 1912, the API client 512 accesses an applicable configuration drift from the configuration reconciler service. At block 1914, the orchestration service 504 determines if an additional manager service manages the resource. In the illustrated example of FIG. 19, based on (e.g., in response to) the orchestration service 504 determining that there is an additional manager service that manages the resource (block 1914: YES), the machine-readable instructions and/or the operations 1900 return to block 1910. Based on (e.g., in response to) the orchestration service 504 determining that there is not an additional manager service that manages the resource (block 1914: NO), the machine-readable instructions and/or the operations 1900 proceed to block 1916.

In the illustrated example of FIG. 19, at block 1916, the orchestration service 504 aggregates one or more applicable configuration drifts returned from the one or more configuration reconciler services. At block 1918, the orchestration service 504 creates a configuration drift map in the orchestrator datastore 510. The example configuration drift map associates the one or more applicable configuration drifts with respective manager services. In the example of FIG. 19, at block 1920, the orchestration service 504 creates a group of the one or more applicable configuration drifts from the configuration drift map per manager service. At block 1922, the API client 512 forwards a child reconciliation precheck request to the one or more configuration reconciler services to perform the precheck on the group per manager service.

FIG. 20 is a flowchart representative of example machine-readable instructions and/or example operations 2000 that may be executed, instantiated, and/or performed by example programmable circuitry to implement the configuration reconciler service 404 of FIG. 5 to respond to a reconciliation precheck request. The example machine-readable instructions and/or the example operations 2000 of FIG. 20 begin at block 2002, at which the API controller 514 monitors an API. At block 2004, the API controller 514 determines if a child reconciliation precheck request has been received. Based on (e.g., in response to), the API controller 514 determining that a child reconciliation precheck request has not been received (block 2004: NO), the machine-readable instructions and/or the operations 2000 return to block 2002.

In the illustrated example of FIG. 20, based on (e.g., in response to), the API controller 514 determining that a child reconciliation precheck request has been received (block 2004: YES), the machine-readable instructions and/or the operations 2000 proceed to block 2006. At block 2006, the reconciliation FSM service 522 identifies a resource associated with the child reconciliation precheck request based on an identifier included with the child reconciliation precheck request. At block 2008, the reconciliation FSM service 522 determines if the resource is a granular resource. Based on (e.g., in response to) the reconciliation FSM service 522 determining that the resource is not a granular resource (block 2008: NO), the machine-readable instructions and/or the operations 2000 proceed to block 2010. At block 2010, the reconciliation FSM service 522 identifies granular resources of the resource (e.g., uber resource) based on a resource map for a domain of the resource. Based on (e.g., in response to) the reconciliation FSM service 522 determining that the resource is a granular resource (block 2008: YES), the machine-readable instructions and/or the operations 2000 proceed to block 2012.

In the illustrated example of FIG. 20, at block 2012, the reconciliation FSM service 522 creates a precheck record in the configuration datastore 406 for a configuration drift identified in the child reconciliation precheck request. At block 2014, the reconciliation FSM service 522 initiates an FSM in a sandbox environment to precheck that a drift recipe will reconcile the configuration drift with the one or more identified resources. At block 2016, the reconciliation FSM service 522 updates the precheck record based on a status of the FSM.

In the illustrated example of FIG. 20, at block 2018, the reconciliation FSM service 522 determines if there is an additional configuration drift identified in the child reconciliation precheck request. Based on (e.g., in response to), the reconciliation FSM service 522 determining that there is an additional configuration drift identified in the child reconciliation precheck request (block 2018: YES), the machine-readable instructions and/or the operations 2000 return to block 2006. Based on (e.g., in response to), the reconciliation FSM service 522 determining that there is not an additional configuration drift identified in the child reconciliation precheck request (block 2018: NO), the machine-readable instructions and/or the operations 2000 terminate.

FIG. 21 is a block diagram of an example programmable circuitry platform 2100 structured to execute and/or instantiate the example machine-readable instructions and/or the example operations of FIGS. 12, 15, 17, and/or 19 to implement the configuration drift reconciliation orchestrator 402 of FIG. 4 and/or the example machine-readable instructions and/or perform the example operations of FIGS. 13, 14, 16, 18, and/or 20 to implement the configuration reconciler service 404 of FIG. 4. The programmable circuitry platform 2100 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 2100 of the illustrated example includes programmable circuitry 2112. The programmable circuitry 2112 of the illustrated example is hardware. For example, the programmable circuitry 2112 can be implemented by one or more integrated circuits, logic circuits, FPGAs, microprocessors, CPUs, GPUs, DSPs, and/or microcontrollers from any desired family or manufacturer. The programmable circuitry 2112 may be implemented by one or more semiconductor based (e.g., silicon based) devices. In this example, the programmable circuitry 2112 implements the example API controller 502, the example orchestration service 504, the example configuration sequence service 506, the example orchestrator DAL interface 508, the example API client 512, and/or, more generally, the example configuration drift reconciliation orchestrator 402 of FIG. 5 and/or the example API controller 514, the example drift detector service 516, the example resource mapping service 518, the example applicability service 520, the example reconciliation FSM service 522, the example configuration reconciler service DAL interface 524, and/or, more generally, the example configuration reconciler service 404 of FIG. 5

The programmable circuitry 2112 of the illustrated example includes a local memory 2113 (e.g., a cache, registers, etc.). The programmable circuitry 2112 of the illustrated example is in communication with main memory 2114, 2116, which includes a volatile memory 2114 and a non-volatile memory 2116, by a bus 2118. The volatile memory 2114 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 2116 may be implemented by flash memory and/or any other desired type of memory device. Access to the main memory 2114, 2116 of the illustrated example is controlled by a memory controller 2117. In some examples, the memory controller 2117 may be implemented by one or more integrated circuits, logic circuits, microcontrollers from any desired family or manufacturer, or any other type of circuitry to manage the flow of data going to and from the main memory 2114, 2116.

The programmable circuitry platform 2100 of the illustrated example also includes interface circuitry 2120. The interface circuitry 2120 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 2122 are connected to the interface circuitry 2120. The input device(s) 2122 permit(s) a user (e.g., a human user, a machine user, etc.) to enter data and/or commands into the programmable circuitry 2112. The input device(s) 2122 can be implemented by, for example, an audio sensor, a microphone, a camera (still or video), a keyboard, a button, a mouse, a touchscreen, a trackpad, a trackball, an isopoint device, and/or a voice recognition system.

One or more output devices 2124 are also connected to the interface circuitry 2120 of the illustrated example. The output device(s) 2124 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 2120 of the illustrated example, thus, typically includes a graphics driver card, a graphics driver chip, and/or graphics processor circuitry such as a GPU.

The interface circuitry 2120 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 2126. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 2100 of the illustrated example also includes one or more mass storage discs or devices 2128 to store firmware, software, and/or data. In this example, the one or more mass storage discs or device 2128 includes the example configuration datastore 406 and the example orchestrator datastore 510.

Examples of such mass storage discs or devices 2128 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine-readable instructions 2132, which may be implemented by the machine-readable instructions of FIGS. 12, 13, 14, 15, 16, 17, 18, 19, and/or 20, may be stored in the mass storage device 2128, in the volatile memory 2114, in the non-volatile memory 2116, and/or on at least one non-transitory computer-readable storage medium such as a CD or DVD which may be removable.

FIG. 22 is a block diagram of an example implementation of the programmable circuitry 2112 of FIG. 21. In this example, the programmable circuitry 2112 of FIG. 21 is implemented by a microprocessor 2200. For example, the microprocessor 2200 may be a general-purpose microprocessor (e.g., general-purpose microprocessor circuitry). The microprocessor 2200 executes some or all of the machine-readable instructions of the flowcharts of FIGS. 12, 13, 14, 15, 16, 17, 18, 19, and/or 20 to effectively instantiate the circuitry of FIG. 5 as logic circuits to perform operations corresponding to those machine-readable instructions. In some such examples, the circuitry of FIG. 5 is instantiated by the hardware circuits of the microprocessor 2200 in combination with the machine-readable instructions. For example, the microprocessor 2200 may be implemented by multi-core hardware circuitry such as a CPU, a DSP, a GPU, an XPU, etc. Although it may include any number of example cores 2202 (e.g., 1 core), the microprocessor 2200 of this example is a multi-core semiconductor device including N cores. The cores 2202 of the microprocessor 2200 may operate independently or may cooperate to execute machine-readable instructions. For example, machine code corresponding to a firmware program, an embedded software program, or a software program may be executed by one of the cores 2202 or may be executed by multiple ones of the cores 2202 at the same or different times. In some examples, the machine code corresponding to the firmware program, the embedded software program, or the software program is split into threads and executed in parallel by two or more of the cores 2202. The software program may correspond to a portion or all of the machine-readable instructions and/or operations represented by the flowcharts of FIGS. 12, 13, 14, 15, 16, 17, 18, 19, and/or 20.

The cores 2202 may communicate by a first example bus 2204. In some examples, the first bus 2204 may be implemented by a communication bus to effectuate communication associated with one(s) of the cores 2202. For example, the first bus 2204 may be implemented by at least one of an Inter-Integrated Circuit (I2C) bus, a Serial Peripheral Interface (SPI) bus, a PCI bus, or a PCIe bus. Additionally or alternatively, the first bus 2204 may be implemented by any other type of computing or electrical bus. The cores 2202 may obtain data, instructions, and/or signals from one or more external devices by example interface circuitry 2206. The cores 2202 may output data, instructions, and/or signals to the one or more external devices by the interface circuitry 2206. Although the cores 2202 of this example include example local memory 2220 (e.g., Level 1 (L1) cache that may be split into an L1 data cache and an L1 instruction cache), the microprocessor 2200 also includes example shared memory 2210 that may be shared by the cores (e.g., Level 2 (L2 cache)) for high-speed access to data and/or instructions. Data and/or instructions may be transferred (e.g., shared) by writing to and/or reading from the shared memory 2210. The local memory 2220 of each of the cores 2202 and the shared memory 2210 may be part of a hierarchy of storage devices including multiple levels of cache memory and the main memory (e.g., the main memory 2114, 2116 of FIG. 21). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 2202 may be referred to as a CPU, DSP, GPU, etc., or any other type of hardware circuitry. Each core 2202 includes control unit circuitry 2214, arithmetic and logic (AL) circuitry (sometimes referred to as an ALU) 2216, a plurality of registers 2218, the local memory 2220, and a second example bus 2222. Other structures may be present. For example, each core 2202 may include vector unit circuitry, single instruction multiple data (SIMD) unit circuitry, load/store unit (LSU) circuitry, branch/jump unit circuitry, floating-point unit (FPU) circuitry, etc. The control unit circuitry 2214 includes semiconductor-based circuits structured to control (e.g., coordinate) data movement within the corresponding core 2202. The AL circuitry 2216 includes semiconductor-based circuits structured to perform one or more mathematic and/or logic operations on the data within the corresponding core 2202. The AL circuitry 2216 of some examples performs integer-based operations. In other examples, the AL circuitry 2216 also performs floating-point operations. In yet other examples, the AL circuitry 2216 may include first AL circuitry that performs integer-based operations and second AL circuitry that performs floating-point operations. In some examples, the AL circuitry 2216 may be referred to as an Arithmetic Logic Unit (ALU).

The registers 2218 are semiconductor-based structures to store data and/or instructions such as results of one or more of the operations performed by the AL circuitry 2216 of the corresponding core 2202. For example, the registers 2218 may include vector register(s), SIMD register(s), general-purpose register(s), flag register(s), segment register(s), machine-specific register(s), instruction pointer register(s), control register(s), debug register(s), memory management register(s), machine check register(s), etc. The registers 2218 may be arranged in a bank as shown in FIG. 22. Alternatively, the registers 2218 may be organized in any other arrangement, format, or structure, such as by being distributed throughout the core 2202 to shorten access time. The second bus 2222 may be implemented by at least one of an I2C bus, a SPI bus, a PCI bus, or a PCIe bus.

Each core 2202 and/or, more generally, the microprocessor 2200 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 2200 is a semiconductor device fabricated to include many transistors interconnected to implement the structures described above in one or more integrated circuits (ICs) contained in one or more packages.

The microprocessor 2200 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 2200, in the same chip package as the microprocessor 2200 and/or in one or more separate packages from the microprocessor 2200.

FIG. 23 is a block diagram of another example implementation of the programmable circuitry 2112 of FIG. 21. In this example, the programmable circuitry 2112 is implemented by FPGA circuitry 2300. For example, the FPGA circuitry 2300 may be implemented by an FPGA. The FPGA circuitry 2300 can be used, for example, to perform operations that could otherwise be performed by the example microprocessor 2200 of FIG. 22 executing corresponding machine-readable instructions. However, once configured, the FPGA circuitry 2300 instantiates the operations and/or functions corresponding to the machine-readable instructions in hardware and, thus, can often execute the operations/functions faster than they could be performed by a general-purpose microprocessor executing the corresponding software.

More specifically, in contrast to the microprocessor 2200 of FIG. 22 described above (which is a general purpose device that may be programmed to execute some or all of the machine-readable instructions represented by the flowchart(s) of FIGS. 12, 13, 14, 15, 16, 17, 18, 19, and/or 20 but whose interconnections and logic circuitry are fixed once fabricated), the FPGA circuitry 2300 of the example of FIG. 23 includes interconnections and logic circuitry that may be configured, structured, programmed, and/or interconnected in different ways after fabrication to instantiate, for example, some or all of the operations/functions corresponding to the machine-readable instructions represented by the flowchart(s) of FIGS. 12, 13, 14, 15, 16, 17, 18, 19, and/or 20. In particular, the FPGA circuitry 2300 may be thought of as an array of logic gates, interconnections, and switches. The switches can be programmed to change how the logic gates are interconnected by the interconnections, effectively forming one or more dedicated logic circuits (unless and until the FPGA circuitry 2300 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 12, 13, 14, 15, 16, 17, 18, 19, and/or 20. As such, the FPGA circuitry 2300 may be configured and/or structured to effectively instantiate some or all of the operations/functions corresponding to the machine-readable instructions of the flowchart(s) of FIGS. 12, 13, 14, 15, 16, 17, 18, 19, and/or 20 as dedicated logic circuits to perform the operations/functions corresponding to those software instructions in a dedicated manner analogous to an ASIC. Therefore, the FPGA circuitry 2300 may perform the operations/functions corresponding to the some or all of the machine-readable instructions of FIGS. 12, 13, 14, 15, 16, 17, 18, 19, and/or 20 faster than the general-purpose microprocessor can execute the same.

In the example of FIG. 23, the FPGA circuitry 2300 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 2300 of FIG. 23 may access and/or load the binary file to cause the FPGA circuitry 2300 of FIG. 23 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 2300 of FIG. 23 to cause configuration and/or structuring of the FPGA circuitry 2300 of FIG. 23, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 2300 of FIG. 23 may access and/or load the binary file to cause the FPGA circuitry 2300 of FIG. 23 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 2300 of FIG. 23 to cause configuration and/or structuring of the FPGA circuitry 2300 of FIG. 23, or portion(s) thereof.

The FPGA circuitry 2300 of FIG. 23, includes example input/output (I/O) circuitry 2302 to obtain and/or output data to/from example configuration circuitry 2304 and/or external hardware 2306. For example, the configuration circuitry 2304 may be implemented by interface circuitry that may obtain a binary file, which may be implemented by a bit stream, data, and/or machine-readable instructions, to configure the FPGA circuitry 2300, or portion(s) thereof. In some such examples, the configuration circuitry 2304 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 2306 may be implemented by external hardware circuitry. For example, the external hardware 2306 may be implemented by the microprocessor 2200 of FIG. 22.

The FPGA circuitry 2300 also includes an array of example logic gate circuitry 2308, a plurality of example configurable interconnections 2310, and example storage circuitry 2312. The logic gate circuitry 2308 and the configurable interconnections 2310 are configurable to instantiate one or more operations/functions that may correspond to at least some of the machine-readable instructions of FIGS. 12, 13, 14, 15, 16, 17, 18, 19, and/or 20 and/or other desired operations. The logic gate circuitry 2308 shown in FIG. 23 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 2308 to enable configuration of the electrical structures and/or the logic gates to form circuits to perform desired operations/functions. The logic gate circuitry 2308 may include other electrical structures such as look-up tables (LUTs), registers (e.g., flip-flops or latches), multiplexers, etc.

The configurable interconnections 2310 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 2308 to program desired logic circuits.

The storage circuitry 2312 of the illustrated example is structured to store result(s) of the one or more of the operations performed by corresponding logic gates. The storage circuitry 2312 may be implemented by registers or the like. In the illustrated example, the storage circuitry 2312 is distributed amongst the logic gate circuitry 2308 to facilitate access and increase execution speed.

The example FPGA circuitry 2300 of FIG. 23 also includes example dedicated operations circuitry 2314. In this example, the dedicated operations circuitry 2314 includes special purpose circuitry 2316 that may be invoked to implement commonly used functions to avoid the need to program those functions in the field. Examples of such special purpose circuitry 2316 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 2300 may also include example general purpose programmable circuitry 2318 such as an example CPU 2320 and/or an example DSP 2322. Other general purpose programmable circuitry 2318 may additionally or alternatively be present such as a GPU, an XPU, etc., that can be programmed to perform other operations.

Although FIGS. 22 and 23 illustrate two example implementations of the programmable circuitry 2112 of FIG. 21, many other approaches are contemplated. For example, FPGA circuitry may include an on-board CPU, such as one or more of the example CPU 2320 of FIG. 22. Therefore, the programmable circuitry 2112 of FIG. 21 may additionally be implemented by combining at least the example microprocessor 2200 of FIG. 22 and the example FPGA circuitry 2300 of FIG. 23. In some such hybrid examples, one or more cores 2202 of FIG. 22 may execute a first portion of the machine-readable instructions represented by the flowchart(s) of FIGS. 12, 13, 14, 15, 16, 17, 18, 19, and/or 20 to perform first operation(s)/function(s), the FPGA circuitry 2300 of FIG. 23 may be configured and/or structured to perform second operation(s)/function(s) corresponding to a second portion of the machine-readable instructions represented by the flowcharts of FIGS. 12, 13, 14, 15, 16, 17, 18, 19, and/or 20, and/or an ASIC may be configured and/or structured to perform third operation(s)/function(s) corresponding to a third portion of the machine-readable instructions represented by the flowcharts of FIGS. 12, 13, 14, 15, 16, 17, 18, 19, and/or 20.

It should be understood that some or all of the circuitry of FIG. 5 may, thus, be instantiated at the same or different times. For example, same and/or different portion(s) of the microprocessor 2200 of FIG. 22 may be programmed to execute portion(s) of machine-readable instructions at the same and/or different times. In some examples, same and/or different portion(s) of the FPGA circuitry 2300 of FIG. 23 may be configured and/or structured to perform operations/functions corresponding to portion(s) of machine-readable instructions at the same and/or different times.

In some examples, some or all of the circuitry of FIG. 5 may be instantiated, for example, in one or more threads executing concurrently and/or in series. For example, the microprocessor 2200 of FIG. 22 may execute machine-readable instructions in one or more threads executing concurrently and/or in series. In some examples, the FPGA circuitry 2300 of FIG. 23 may be configured and/or structured to carry out operations/functions concurrently and/or in series. Moreover, in some examples, some or all of the circuitry of FIG. 5 may be implemented within one or more virtual machines and/or containers executing on the microprocessor 2200 of FIG. 22.

In some examples, the programmable circuitry 2112 of FIG. 21 may be in one or more packages. For example, the microprocessor 2200 of FIG. 22 and/or the FPGA circuitry 2300 of FIG. 23 may be in one or more packages. In some examples, an XPU may be implemented by the programmable circuitry 2112 of FIG. 21, which may be in one or more packages. For example, the XPU may include a CPU (e.g., the microprocessor 2200 of FIG. 22, the CPU 2320 of FIG. 23, etc.) in one package, a DSP (e.g., the DSP 2322 of FIG. 23) in another package, a GPU in yet another package, and an FPGA (e.g., the FPGA circuitry 2300 of FIG. 23) in still yet another package.

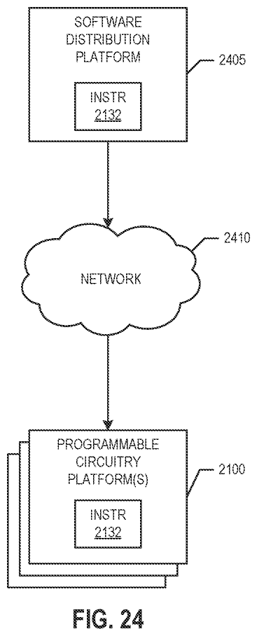

A block diagram illustrating an example software distribution platform 2405 to distribute software such as the example machine-readable instructions 2132 of FIG. 21 to other hardware devices (e.g., hardware devices owned and/or operated by third parties from the owner and/or operator of the software distribution platform) is illustrated in FIG. 24. The example software distribution platform 2405 may be implemented by any computer server, data facility, cloud service, etc., capable of storing and transmitting software to other computing devices. The third parties may be customers of the entity owning and/or operating the software distribution platform 2405. For example, the entity that owns and/or operates the software distribution platform 2405 may be a developer, a seller, and/or a licensor of software such as the example machine-readable instructions 2132 of FIG. 21. The third parties may be consumers, users, retailers, OEMs, etc., who purchase and/or license the software for use and/or re-sale and/or sub-licensing. In the illustrated example, the software distribution platform 2405 includes one or more servers and one or more storage devices. The storage devices store the machine-readable instructions 2132, which may correspond to the example machine-readable instructions of FIGS. 12, 13, 14, 15, 16, 17, 18, 19, and/or 20, as described above. The one or more servers of the example software distribution platform 2405 are in communication with an example network 2410, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third-party payment entity. The servers enable purchasers and/or licensors to download the machine-readable instructions 2132 from the software distribution platform 2405. For example, the software, which may correspond to the example machine-readable instructions of FIGS. 12, 13, 14, 15, 16, 17, 18, 19, and/or 20, may be downloaded to the example programmable circuitry platform 2100, which is to execute the machine-readable instructions 2132 to implement the configuration drift reconciliation orchestrator 402 of FIG. 4 and/or the configuration reconciler service 404 of FIG. 4. In some examples, one or more servers of the software distribution platform 2405 periodically offer, transmit, and/or force updates to the software (e.g., the example machine-readable instructions 2132 of FIG. 21) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that allow for controlled application of updates and/or patches to configurations of deployed resources in a cloud computing environment. As such, configuration updates and/or fixes can be selectively applied to a deployment at will which reduces the likelihood that a configuration update and/or fix will cause an error in the deployment. Disclosed systems, apparatus, articles of manufacture, and methods improve the efficiency of using a computing device by reducing downtime of a deployment and avoiding instances where manual intervention may be required to correct a configuration update error. Disclosed systems, apparatus, articles of manufacture, and methods are accordingly directed to one or more improvement(s) in the operation of a machine such as a computer or other electronic and/or mechanical device.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
interface circuitry;
machine-readable instructions; and
programmable circuitry to at least one of instantiate or execute the machine-readable instructions to:
identify a resource associated with a request to reconcile an updated configuration with the resource, the resource to be identified based on a first identifier of the resource included with the request;
identify a finite state machine corresponding to the updated configuration based on a second identifier of the updated configuration included with the request; and
initiate the finite state machine corresponding to the updated configuration to reconcile the updated configuration with the resource.

2. The apparatus of claim 1, wherein a domain includes the resource, and the programmable circuitry is to:
identify a cluster that is to host at least one of the domain, a virtualization management instance of the domain, or a server management instance of the domain;
identify one or more physical devices of the cluster; and
populate a resource map of the domain based on the server management instance, the virtualization management instance, the cluster, and the one or more physical devices.

3. The apparatus of claim 1, wherein the programmable circuitry is to, based on a drift availability request from an orchestrator:
identify the resource as associated with the drift availability request based on a third identifier included with the drift availability request; and
access at least one of a reconciliation record associated with the resource, configuration drift metadata indicative of a version of the resource to which the updated configuration is applicable, or a node of a resource map corresponding to the resource.

4. The apparatus of claim 3, wherein the programmable circuitry is to determine whether the updated configuration is applicable to the resource based on at least one of the reconciliation record, the configuration drift metadata, or a present status of the node corresponding to the resource.

5. The apparatus of claim 3, wherein the programmable circuitry is to, based on identifying that the resource is an uber resource, identify two or more granular resources of the uber resource based on the resource map.

6. The apparatus of claim 1, wherein the programmable circuitry is to:
create a reconciliation record in a datastore for the request; and
update the reconciliation record based on a status of the finite state machine.

7. The apparatus of claim 1, wherein the updated configuration is a first updated configuration, and the programmable circuitry is to initiate the finite state machine to reconcile the first updated configuration and a second updated configuration with the resource.

8. A non-transitory machine-readable storage medium comprising instructions to cause programmable circuitry to at least:
identify a resource associated with a request to reconcile an updated configuration with the resource, the resource to be identified based on a first identifier of the resource included with the request;
identify a finite state machine corresponding to the updated configuration based on a second identifier of the updated configuration included with the request; and
initiate the finite state machine corresponding to the updated configuration to reconcile the updated configuration with the resource.

9. The non-transitory machine-readable storage medium of claim 8, wherein a domain includes the resource, and the instructions are to cause the programmable circuitry to:
identify a cluster that is to host at least one of the domain, a virtualization management instance of the domain, or a server management instance of the domain;
identify one or more physical devices of the cluster; and
populate a resource map of the domain based on the server management instance, the virtualization management instance, the cluster, and the one or more physical devices.

10. The non-transitory machine-readable storage medium of claim 8, wherein the instructions are to cause the programmable circuitry to, based on a drift availability request from an orchestrator:
identify the resource as associated with the drift availability request based on a third identifier included with the drift availability request; and
access at least one of a reconciliation record associated with the resource, configuration drift metadata indicative of a version of the resource to which the updated configuration is applicable, or a node of a resource map corresponding to the resource.

11. The non-transitory machine-readable storage medium of claim 10, wherein the instructions are to cause the programmable circuitry to determine whether the updated configuration is applicable to the resource based on at least one of the reconciliation record, the configuration drift metadata, or a present status of the node corresponding to the resource.

12. The non-transitory machine-readable storage medium of claim 10, wherein the instructions are to cause the programmable circuitry to, based on identifying that the resource is an uber resource, identify two or more granular resources of the uber resource based on the resource map.

13. The non-transitory machine-readable storage medium of claim 8, wherein the instructions are to cause the programmable circuitry to:
create a reconciliation record in a datastore for the request; and
update the reconciliation record based on a status of the finite state machine.

14. The non-transitory machine-readable storage medium of claim 8, wherein the updated configuration is a first updated configuration, and the instructions are to cause the programmable circuitry to initiate the finite state machine to reconcile the first updated configuration and a second updated configuration with the resource.

15. A method comprising:
identifying, by executing an instruction with programmable circuitry, a resource associated with a request to reconcile an updated configuration with the resource, the resource to be identified based on a first identifier of the resource included with the request;
identifying, by executing an instruction with the programmable circuitry, a finite state machine corresponding to the updated configuration based on a second identifier of the updated configuration included with the request; and
initiating, by executing an instruction with the programmable circuitry, the finite state machine corresponding to the updated configuration to reconcile the updated configuration with the resource.

16. The method of claim 15, wherein a domain includes the resource, and the method further includes:
identifying a cluster that is to host at least one of the domain, a virtualization management instance of the domain, or a server management instance of the domain;
identifying one or more physical devices of the cluster; and
populating a resource map of the domain based on the server management instance, the virtualization management instance, the cluster, and the one or more physical devices.

17. The method of claim 15, further including, based on a drift availability request from an orchestrator:
identifying the resource as associated with the drift availability request based on a third identifier included with the drift availability request; and
accessing at least one of a reconciliation record associated with the resource, configuration drift metadata indicative of a version of the resource to which the updated configuration is applicable, or a node of a resource map corresponding to the resource.

18. The method of claim 17, further including determining whether the updated configuration is applicable to the resource based on at least one of the reconciliation record, the configuration drift metadata, or a present status of the node corresponding to the resource.

19. The method of claim 17, further including, based on identifying that the resource is an uber resource, identifying two or more granular resources of the uber resource based on the resource map.

20. The method of claim 15, further including:
creating a reconciliation record in a datastore for the request; and
updating the reconciliation record based on a status of the finite state machine.

21. The method of claim 15, wherein the updated configuration is a first updated configuration, and the method further includes initiating the finite state machine to reconcile the first updated configuration and a second updated configuration with the resource.
